(19) United States
(12) Patent Application Publication
(10) Pub. No.: US 2026/0333437 A1
(43) Pub. Date: Oct. 22, 2026

(54) Transmission Opportunity (TXOP) Protection for Coordinated Time Divisional Multiple Access (CTDMA)

(71) Applicant: Ofinno, LLC, Reston, VA (US)

(72) Inventors: Leonardo Alisasis Lanante, Reston, VA (US); Jeongki Kim, Fairfax, VA (US); Esmael Hejazi Dinan, McLean, VA (US); Serhat Erkucuk, Reston, VA (US); Jiayi Zhang, Rockville, MD (US); Tuncer Baykas, Reston, VA (US)

(73) Assignee: Ofinno, LLC, Reston, VA (US)

(21) Appl. No.: 19/700,575

(22) Filed: Jun. 8, 2026

Related U.S. Application Data
(63) Continuation of application No. PCT/US2024/061830, filed on Dec. 24, 2024.
(60) Provisional application No. 63/614,715, filed on Dec. 26, 2023.
(60) Provisional application No. 63/622,642, filed on Jan. 19, 2024.

(51) Int. Cl. H04W 74/0816; H04L 5/00; H04W 28/02; H04W 74/00

(52) U.S. Cl. CPC H04W 74/0816; H04L 5/0053; H04W 28/0278; H04W 74/002

(57) ABSTRACT

A first station (STA) transmits to a second STA a first frame during a transmit opportunity (TXOP) obtained by the first STA, the first frame comprising: an allocation duration field indicating a first duration, within the TXOP, allocated to the second STA; and an indication of a transmission by the first STA of a second frame within the first duration. The first STA transmits during the first duration the second frame.

### CROSS-REFERENCE TO RELATED APPLICATIONS

This application is a continuation of International Application No. PCT/US2024/061830, filed Dec. 24, 2024, which claims the benefit of U.S. Provisional Application No. 63/622,642, filed Jan. 19, 2024, and U.S. Provisional Application No. 63/614,715, filed Dec. 26, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example multi-AP network.

FIG. 4 illustrates Enhanced Distributed Channel Access (EDCA) and Coordinated Orthogonal Frequency Division Multiple Access (COFDMA).

FIG. 5 illustrates an example network that includes a coordinated AP set.

FIG. 6 illustrates an example multi-AP operation procedure.

FIG. 7 illustrates an example multi-AP sounding phase.

FIG. 8 illustrates an example multi-AP downlink data transmission phase.

FIG. 9 illustrates an example multi-AP uplink data transmission phase.

FIG. 10 illustrates an example trigger frame.

FIG. 11 illustrates an example multi-user request to send (MU-RTS) trigger frame.

FIG. 12 illustrates an example of a Multi-User Request-to-Send (MU-RTS) trigger frame which may be used in a triggered Transmit Opportunity (TXOP) sharing (TXS) procedure.

FIG. 13 illustrates an example of a triggered TXS procedure (Mode=1).

FIG. 14 illustrates an example of a triggered TXS procedure (Mode=2).

FIG. 15 illustrates an example of an existing Coordinated Time Division Multiple Access (CTDMA) procedure.

FIG. 16 illustrates an example of another existing CTDMA procedure.

FIG. 17 illustrates a problem that may arise in the CTDMA procedure of FIG. 16

FIG. 18 illustrates an example of another CTDMA procedure.

FIG. 19 illustrates an example of a CTDMA procedure according to an embodiment.

FIG. 20 illustrates an example of another CTDMA procedure according to an embodiment.

FIG. 21 illustrates an example of another CTDMA procedure according to an embodiment.

FIG. 22 illustrates an example process according to an embodiment.

FIG. 23 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B ={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

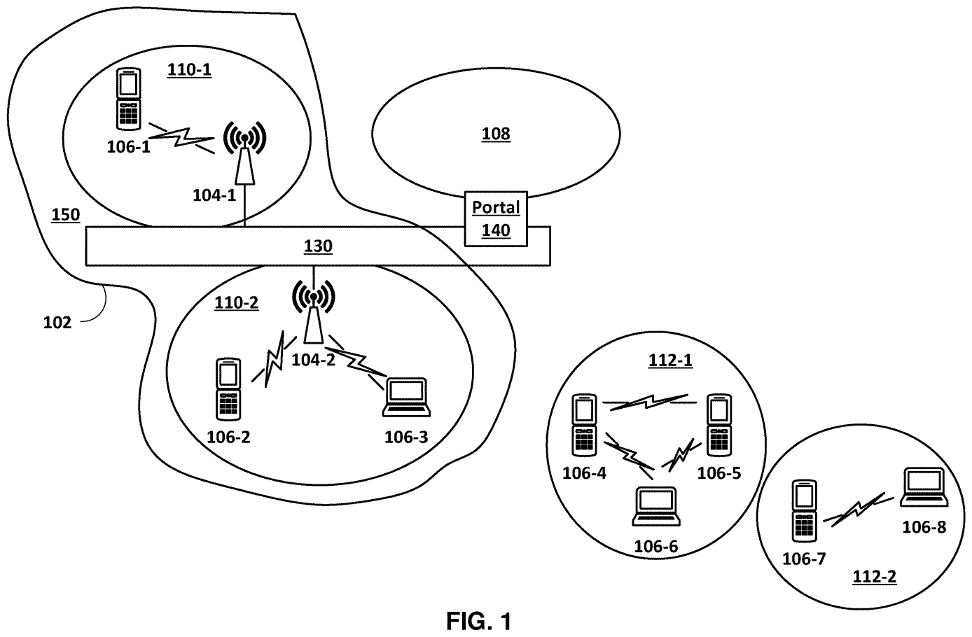

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 520 MHz by bonding together multiple 20 MHz channels.

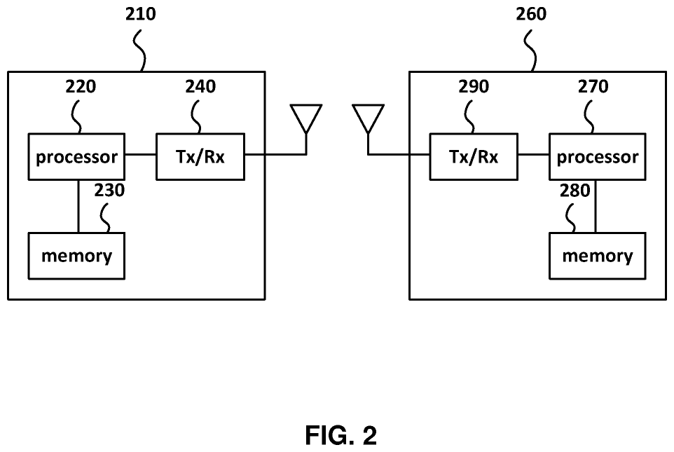

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

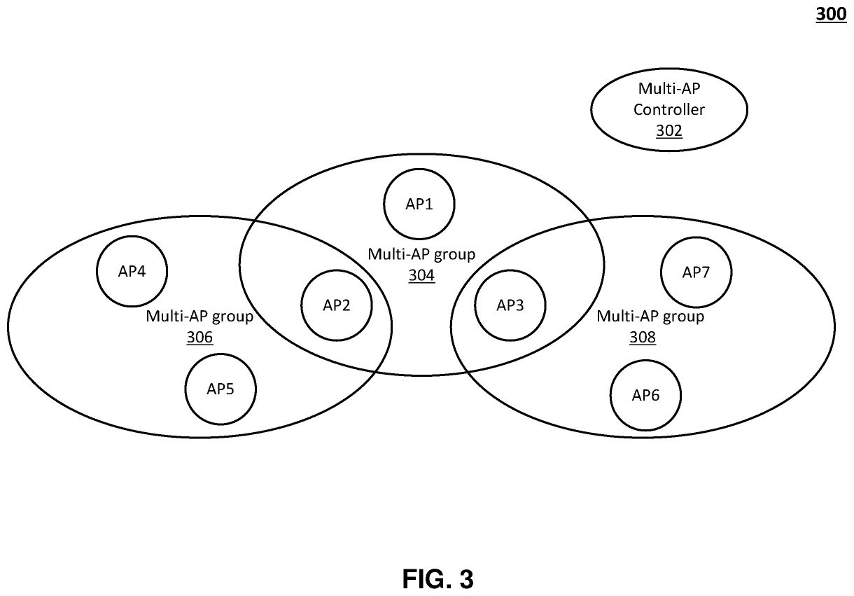

FIG. 3 illustrates an example multi-AP network 300. Example multi-AP network 300 may be a multi-AP network in accordance with the Wi-Fi Alliance standard specification for multi-AP networks. As shown in FIG. 3, multi-AP network 300 may include a multi-AP controller 302 and a plurality of multi-AP groups (or multi-AP sets) 304, 306, and 308.

Multi-AP controller 302 may be a logical entity that implements logic for controlling the APs in multi-AP network 300. Multi-AP controller 302 may receive capability information and measurements from the APs and may trigger AP control commands and operations on the APs. Multi-AP controller 302 may also provide onboarding functionality to onboard and provision APs onto multi-AP network 300.

Multi-AP groups 304, 306, and 308 may each include a plurality of APs. APs in a multi-AP group are in communication range of each other and may coordinate their transmissions and/or transmissions from their associated STAs. Coordinated transmissions may involve all or a subset of the APs in a multi-AP group. A multi-AP group may also be referred to as an AP candidate set as APs in a multi-AP group are considered candidates for a coordinated transmission initiated by an AP. The APs in a multi-AP group are not required to have the same primary channel. As used herein, the primary channel for an AP refers to a default channel that the AP monitors for management frames and/or uses to transmit beacon frames. For a STA associated with an AP, the primary channel refers to the primary channel of the AP, which is advertised through the AP's beacon frames.

In one approach, a multi-AP group may be established by a coordinator AP in a multi-AP setup phase prior to any multi-AP coordination. APs of the multi-AP group, other than the coordinator AP, may be referred to as the coordinated APs. A coordinator AP may establish one or more multi-AP groups. A coordinated AP may likewise be a member of multiple multi-AP groups. A coordinator AP of a multi-AP group may be a coordinated AP of another multi-AP group, and vice versa. In another approach, a multi-AP group may be established by a network administrator manually by configuring APs as part of the multi-AP group. In yet another approach, a multi-AP group may be established in a distributed manner by APs without a central controller. In this case, an AP may advertise its multi-AP capability in a beacon or other management frame (e.g., public action frame). Other APs that receive the frame with the multi-AP capability information may perform a multi-AP setup with the AP that advertised the multi-AP capability.

In one approach, one of the APs in a multi-AP group may be designated as a master AP. The designation of the master AP may be done by AP controller 302 or by the APs of the multi-AP group. The master AP of a multi-AP group may be fixed or may change over time between the APs of the multi-AP group. An AP that is not the master AP of the multi-AP group is known as a slave AP.

In one approach, APs in a multi-AP group may perform coordinated transmissions together. One aspect of coordination may include coordination to perform coordinated transmissions within the multi-AP group. As used herein, a coordinated transmission, also referred to as a multi-AP transmission, is a transmission event in which multiple APs (of a multi-AP group or a multi-AP network) transmit in a coordinated manner over a time period. Coordinated transmissions may involve simultaneous transmissions of a plurality of APs in a multi-AP group. The time period of simultaneous AP transmission may be a continuous period. The multi-AP transmission may use different transmission techniques, such as Coordinated OFDMA (COFDMA), Coordinated Spatial Reuse (CSR), Joint Transmission or Reception (JT/JR), Coordinated Beamforming (CBF), and CTDMA, or a combination of two or more of the aforementioned techniques.

Multi-AP transmissions may be enabled by the AP controller and/or by the master AP of the multi-AP group. In one approach, the AP controller and/or the master AP may control time and/or frequency sharing in a transmission opportunity (TXOP). For example, when one of the APs (e.g., the master AP) in the multi-AP group obtains a TXOP, the AP controller and/or the master AP may control how time/frequency resources of the TXOP are to be shared with other APs of the multi-AP group. In an implementation, the AP of the multi-AP group that obtains a TXOP becomes the master AP of the multi-AP group. The master AP may then share a portion of its obtained TXOP (which may be the entire TXOP) with one or more other APs of the multi-AP group.

Different multi-AP transmission schemes may be suitable for different use cases in terms of privacy protection, including whether transmitted data may be shared with other BSSs in the multi-AP group. For example, some multi-AP transmission schemes, such as CSR, CDTMA, coordinated frequency division multiple access (CFDMA), COFDMA, and CBF, enable a master AP to coordinate slave APs by sharing control information among APs, without requiring the sharing of user data among APs. The control information may include BSS information of APs, link quality information of channels between each AP and its associated STAs, and information related to resources to be used to achieve multiplexing in power, time, frequency, or special domains for multi-AP transmission. The control information exchanged among a master AP and slave APs may be used for interference avoidance or nulling to avoid or null co-channel interference introduced to neighboring BSSs in a multi-AP network. Interference avoidance or interference nulling requires that data transmissions between an AP and STAs are only within the same BSS. In other words, each AP transmits or receives data frames to or from its associated STAs, while each STA receives or transmits data frames to or from its associating AP.

By contrast, other multi-AP transmission schemes may enable a master AP to coordinate slave APs by sharing both control information and user data among APs in a multi-AP group. Control information may include BSS information related to APs and link quality information of channels between each AP and its associated STAs. By having user data exchanged over backhaul, the master AP and slave APs may perform data transmissions jointly to achieve spatial diversity, e.g., using distributed MIMO, for example, joint transmission (JT) for downlink transmissions and joint reception (JR) for uplink transmissions. The data transmissions between APs and STAs may include transmissions within the same BSS and/or across different BSSs. In other words, an AP may transmit or receive data frames to or from its associated STAs as well STAs associated with other APs participating in multi-AP transmission. Similarly, a STA may transmit or receive data frames to or from multiple APs.

Different multi-AP transmission schemes may be suitable for different use cases in terms of signal reception levels at STAs or APs within a multi-AP group. For example, CBF and JT/JR require that each STA involved in a multi-AP transmission be located within a common area of signal coverage of the APs involved in the multi-AP transmission. Generally, CBF may be suitable when a receiving STA suffers from potential interference from other APs in the multi-AP group. By using channel related information such as channel state information (CSI), channel quality indication (CQI), or compressed beamforming (BF) feedback exchanged among APs, an AP may pre-code a signal to be transmitted to form a beam that increases power toward a target STA while reducing the power that interferes with a STA associated with a neighboring AP. Use cases of JT/JR may require a sufficient received signal power at receiving STAs for JT and a sufficient received signal power at receiving APs for JR. By contrast, CSR may perform multi-AP transmission in an interference coordination manner. The received signal power at a STA associated with an AP transmitting data may be required to be much higher than the received interference power.

Different multi-AP transmission schemes may require different synchronization levels and may operate with or without a backhaul between a master AP and slave APs in a multi-AP group. For example, CSR may require PPDU-level synchronization, whereas CBF may require symbol-level synchronization. On the other hand, JT/JR may require tight time/frequency/phase-level synchronization as well as a backhaul for data sharing between APs in the multi-AP group.

Different multi-AP transmission schemes may have different complexity levels with regard to coordination between a master AP and slave APs in a multi-AP group. For example, JT/JR may require very high complexity due to both CSI and user data being shared between APs. CBF may require medium complexity due to the sharing of CSI. CFDMA, COFDMA and CTDMA may require medium or relatively low complexity due to the CSI and time/frequency resources to be shared between APs. CSR may require low complexity as the amount of information related to spatial reuse and traffic that needs to be exchanged between APs may be low.

A multi-AP group may adopt a static multi-AP operation including a static multi-AP transmission scheme. A multi-AP network may also be dynamic due to various reasons. For example, a STA may join or leave the multi-AP network, a STA may switch to a power save mode, or an AP or a STA may change its location. Such changes may lead to changes in the conditions underlying the selection of the multi-AP transmission scheme and may cause certain requirements (e.g., synchronization, backhaul, coordination, etc.) for the multi-AP transmission scheme to be lost. This results in an inferior quality of transmissions in the multi-AP network.

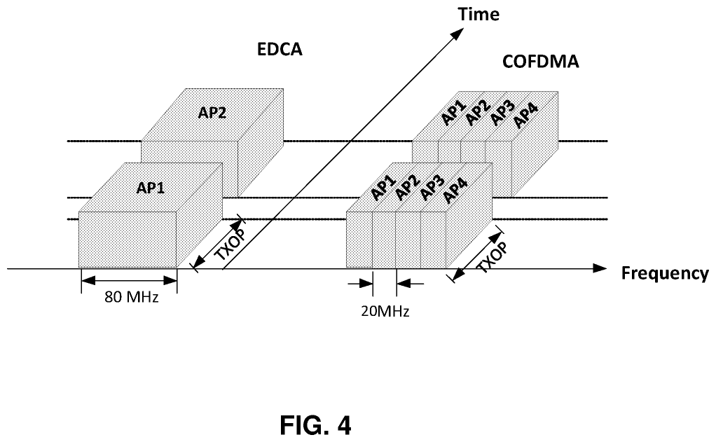

In COFDMA, the master AP may share a portion of its TXOP with multiple APs by assigning each of the multiple APs a respective frequency resource (e.g., channel/subchannel) of available frequency resources. COFDMA is illustrated in FIG. 4 as a multi-AP channel access, compared with Enhanced Distributed Channel Access (EDCA). As shown in FIG. 4, in EDCA, channel access by multiple APs (e.g., AP1, AP2) may occur in consecutive time periods (e.g., TXOPs). During a given channel access, the channel (e.g., 80 MHz) in its entirety may be used by a single AP. In contrast, in COFDMA, access by multiple APs (multi-AP channel access) may take place in a same time period (e.g., same TXOP or same portion of a TXOP) over orthogonal frequency resources. For example, as shown in FIG. 4, an 80 MHz channel may be divided into four non-overlapping 20 MHz channels, each assigned to a respective AP of the multiple APs. The multiple APs may transmit in a coordinated manner, simultaneously in the same time period, to achieve a multi-AP transmission. In the multi-AP transmission, each of the multiple APs may transmit a PPDU to one or more STAs.

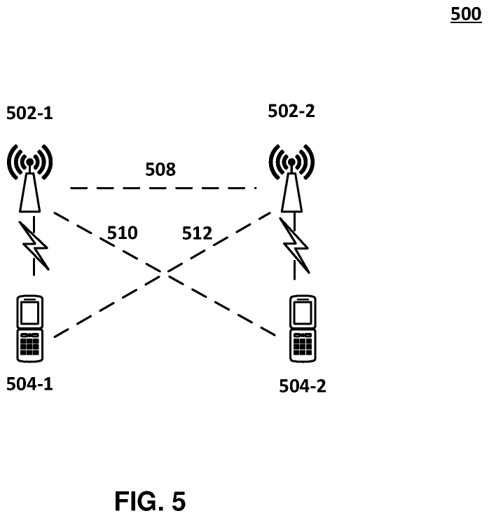

FIG. 5 illustrates an example network 500 that includes a coordinated AP set. As shown in FIG. 5, the coordinated AP set may include two APs-AP 502-1 and AP 502-2. The coordinated AP set may be a subset of an established multi-AP group. At least one STA may be associated with each of APs 502-1 and 502-2. For example, a STA 504-1 may be associated with AP 502-1, and a STA 504-2 may be associated with AP 502-2.

APs 502-1 and 502-2 may belong to the same ESS as described above in FIG. 1. In such a case, APs 502-1 and 502-2 may be connected by a DS to support ESS features. In addition, as part of a coordinated AP set, APs 502-1 and 502-2 may be connected by a backhaul. The backhaul is used to share information quickly between APs to support coordinated transmissions. The shared information may be channel state information or data to be sent to associated STAs. The backhaul may be a wired backhaul or a wireless backhaul. A wired backhaul is preferred for high-capacity information transfer without burdening the main radios of the APs. However, a wired backhaul may require a higher deployment cost and may place greater constraints on AP placement. A wireless backhaul is preferred for its lower deployment cost and flexibility regarding AP placement. However, because a wireless backhaul relies on the main radios of the APs to transfer information, the APs cannot transmit or receive any data while the wireless backhaul is being used.

Typically, one of APs 502-1 and 502-2 may act as a Master AP and the other as a Slave AP. The Master AP is the AP that is the owner of the TXOP. The Master AP shares frequency resources during the TXOP with the Slave AP. When there are more than two APs in the coordinated set, a Master AP may share its TXOP with only a subset of the coordinated AP set. The role of the Master AP may change over time. For example, the Master AP role may be assigned to a specific AP for a duration of time. Similarly, the Slave AP role may be chosen by the Master AP dynamically or can be pre-assigned for a duration of time.

Depending on the capability of APs in a coordinated AP set, the APs may only do certain type of coordinated transmissions. For example, in FIG. 5, if AP 502-1 supports JT and CSR while AP 502-2 supports CSR and CBF, both APs may only perform CSR as a coordinated transmission scheme. An AP may also prefer to perform single AP transmissions for a duration of time if the benefit of coordinated transmission does not outweigh some disadvantages with coordinated transmission such as reduced flexibility and increased computational power required.

CSR is one type of multi-AP coordination that may be supported by AP 501-1 and AP 502-2 as shown in FIG. 5. Spatial reuse using CSR can be more stable than non-AP coordinated spatial reuse schemes such as OBSS PD-based SR and PSR-based SR. For example, in example network 500, APs 502-1 and 502-2 may perform a joint sounding operation in order to measure path loss (PL) on paths of network 500. For example, the joint sounding operation may result in the measurement of PL 508 for the path between APs 502-1 and 502-2, path loss 510 for the path between AP 502-1 and STA 504-2, and path loss 512 for the path between AP 502-2 and STA 504-1. The measured path loss information may then be shared between APs 502-1 and 502-2 (e.g., using the backhaul) to allow for simultaneous transmissions by APs 502-1 and 502-2 to their associated STAs 504-1 and 504-2 respectively. Specifically, one of APs 502-1 and 502-2 obtains a TXOP to become the Master AP. The Master AP may then send a CSR announcement frame to the other AP(s). In an embodiment, the Master AP may perform a polling operation, before sending the CSR announcement frame, to poll Slave APs regarding packet availability for transmission. If at least one Slave AP responds indicating packet availability, the Master AP may proceed with sending the CSR announcement frame. In the CSR announcement, the Master AP may limit the transmit power of a Slave AP in order to protect its own transmission to its target STA. The Slave AP may similarly protect its own transmission to its target STA by choosing a modulation scheme that enables a high enough Signal to Interference Ratio (SIR) margin to support the interference due to the transmission of the Master AP to its target STA.

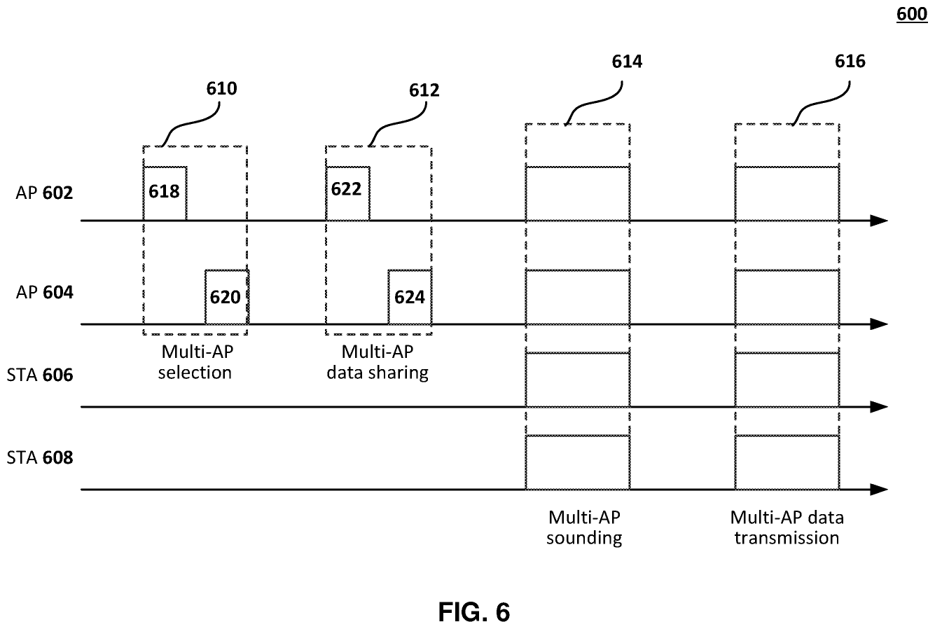

FIG. 6 illustrates an example 600 of a multi-AP operation procedure. In example 600, the multi-AP operation procedure is illustrated with respect to a multi-AP network that includes APs 602 and 604 and STAs 606 and 608. In an example, APs 602 and 604 may form a multi-AP group. AP 602 may be the master AP and AP 604 may be a slave AP of the multi-AP group. For example, AP 602 may obtain a TXOP making it the master AP of the multi-AP group. Alternatively, AP 602 may be designated as the master AP by a multi-AP controller.

As shown in FIG. 6, the multi-AP operation procedure may include a series of phases in time, each of which may contain a plurality of frame exchanges within the multi-AP network. Specifically, the multi-AP operation procedure may include a multi-AP selection phase 610, a multi-AP data sharing phase 612, a multi-AP sounding phase 614, and a multi-AP data transmission phase 616.

A multi-AP network may carry out a multi-AP operation based on a specific multi-AP transmission scheme. The multi-AP transmission scheme may be chosen by the master AP based on the capabilities of the slave APs in a multi-AP group. Prior to a multi-AP operation, a slave AP may inform the master AP of capability information related to the slave AP, including the capabilities of supporting one or more multi-AP transmission schemes. The slave AP may also inform the master AP of BSS information of the BSS of the slave AP and of link quality information for STAs associated with the slave AP. The master AP may receive information related to all available slave APs. The information related to slave APs may include capability information, BSS information, and link quality information. Based on the information provided by available slave APs, the master AP may determine during a multi-AP selection phase the slave APs to be designated for a multi-AP transmission and a specific multi-AP transmission scheme to be used during the multi-AP transmission.

Multi-AP selection phase 610 may include procedures for soliciting, selecting, or designating slave AP(s) for a multi-AP group by a master AP. As seen in FIG. 6, the multi-AP selection phase may include transmissions of frame 618 from AP 602 and frame 620 from AP 604. AP 602 may transmit frame 618 to solicit information regarding the buffer status of AP 604. In response, AP 604 may transmit frame 620 to inform AP 602 of its and its associated STAs buffer status and/or whether it intends to join multi-AP operation. Multi-AP selection phase 610 may also be used to exchange information related to multi-AP operation, including BSS information of APs and link quality information between each AP and its associated STAs, for example. The BSS information of an AP may include a BSS ID of the BSS of the AP, identifiers and/or capabilities of STAs belonging to the BSS, information regarding sounding capabilities of the STAs, information regarding MIMO capabilities of the AP, etc. Link quality information may include received signal strength indicator (RSSI), signal-to-noise ratio (SNR), signal-to-interference-plus-noise-ratio (SINR), channel state information (CSI), channel quality indicator (CQI).

Multi-AP data sharing phase 612 may include procedures for sharing data frames to be transmitted by APs to associated STAs among the master AP and selected slave AP(s) via direct connections between APs. Phase 612 may be optional for some multi-AP data transmission schemes. For example, phase 612 may be required for JT/JR as data frames may be exchanged between APs before or after multi-AP data transmission phase 616.

Multi-AP data sharing phase 612 may be performed using a wired backhaul, an in-channel wireless backhaul, or an off-channel wireless backhaul. In some cases, multi-AP data sharing phase 612 may be performed over an in-channel backhaul, e.g., using the same wireless channel used to transmit/receive data to/from STAs. For example, as shown in FIG. 6, in phase 612, AP 602 may transmit a frame 622, which may be received by AP 604. Frame 622 may include MPDUs that AP 602 wishes to transmit to associated STAs using a multi-AP operation. Similarly, AP 604 may transmit a frame 624, which may be received by AP 602. Frame 624 may include MPDUs that AP 604 wishes to transmit to associated STAs using a multi-AP operation.

Multi-AP sounding phase 614 may include procedures for multi-AP channel sounding, including channel estimation and feedback of channel estimates among the master AP, candidate slave AP(s), and associated STAs. Phase 614 may be optional for some multi-AP transmission schemes, such as COFDMA, CDTMA, and CSR. For example, phase 614 may be performed by the master AP to aid in resource unit allocation when orchestrating a COFDMA transmission.

Multi-AP data transmission phase 616 may include exchange of data frames between the master AP, slave AP(s), and their associated STAs based on multi-AP transmission scheme(s) determined by the master AP. Depending on the multi-AP transmission scheme(s) to be used, phase 616 may include optional synchronization between APs of the multi-AP group, before exchange of data frames between APs and STAs within the multi-AP group.

The order of phases 610, 612, 614 and 616 may be different than shown in FIG. 6. For example, in COFDMA, phase 616 may occur immediately after phase 610, whereas, in JT/JR, phase 612 may occur after phase 610. Further, as mentioned above, some phases may be optional and may or may not be present. For example, phase 614 may not be required for COFDMA but may be required for JT/JR.

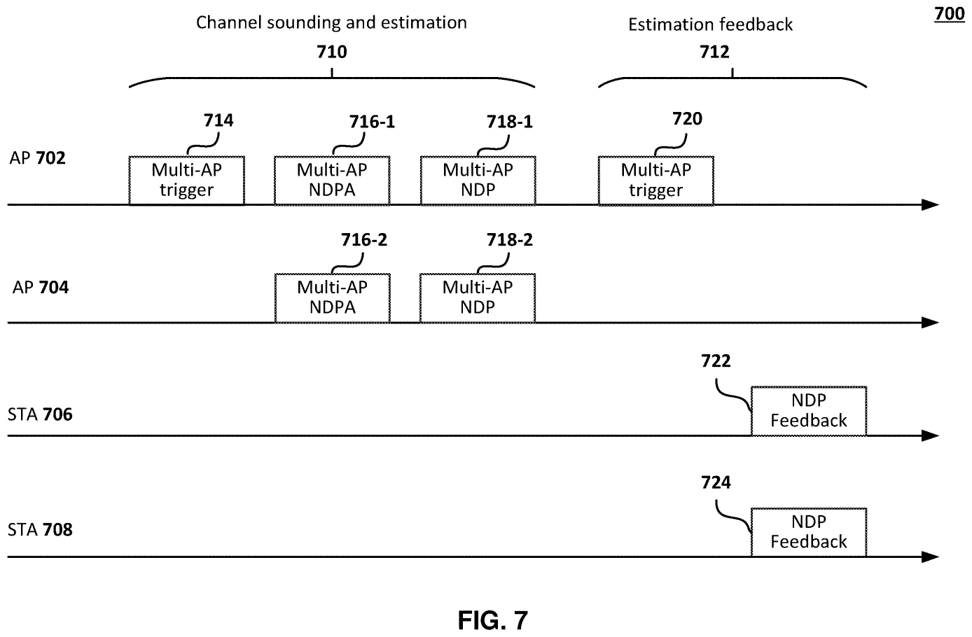

FIG. 7 illustrates an example 700 of a multi-AP sounding phase. Example 700 may be an example of multi-AP sounding phase 614. As shown in FIG. 7, example 700 may include a master AP 702 and a slave AP 704 of a multi-AP group. Example 700 may further include a STA 706 associated with AP 702 and a STA 708 associated with AP 704.

As shown in FIG. 7, example 700 may include frame exchanges to allow AP 702 (the master AP) to acquire channel state information (CSI) of channels in the multi-AP group. In an implementation, example 700 may include a first subphase 710 and a second subphase 712.

During the first subphase 710, APs may initiate channel sounding and STAs may estimate channel state information (CSI). For example, AP 702 may transmit a frame 714 to AP 704 (the slave AP) to trigger multi-AP sounding. Frame 714 may comprise a multi-AP trigger frame. Subsequently, APs 702 and 704 may transmit respectively announcement frames 716-1 and 716-2 to their respective associated STAs 706 and 708 to announce the transmission of sounding frames. Frames 716-1 and 716-2 may comprise multi-AP null data packet announcement (NDPA) frames. Frames 716-1 and 716-2 may be transmitted simultaneously. Next, APs 702 and 704 may transmit respectively frames 718-1 and 718-2 to STAs 706 and 708 respectively. Frames 718-1 and 718-2 may comprise multi-AP null data packet (NDP) frames. STAs 706 and 708 receive frames 718-1 and 718-2 respectively and perform channel estimation of the channels from AP 702 to STA 706 and from AP 704 to STA 708, respectively.

During the second subphase 712, APs may initiate a procedure for STAs to feed back channel estimates to the APs. For example, AP 702 may transmit a frame 720 to trigger STAs 706 and 708 to transmit their channel estimates to APs 702 and 704 respectively. Frame 720 may comprise a multi-AP trigger frame. In response, STAs 706 and 708 may transmit respectively frames 722 and 724 including feedback of channel estimates to APs 702 and 704 respectively. Frames 722 and 724 may comprise NDP feedback frames. The feedback of channel estimates may include NDP feedback, CSI-related information, a beamforming report (BFR), or a channel quality indication (CQI) report.

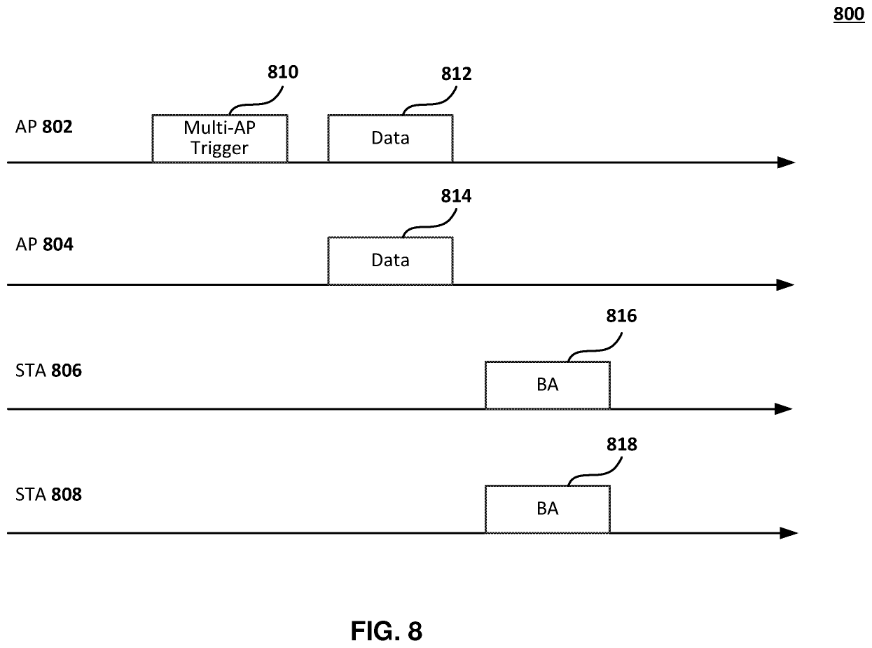

FIG. 8 illustrates an example 800 of a multi-AP downlink data transmission phase. Example 800 may be an example of multi-AP data transmission phase 616. As shown in FIG. 8, example 800 may include a master AP 802 and a slave AP 804 of a multi-AP group. Example 800 may further include a STA 806 associated with AP 802, and a STA 808 associated with AP 804.

As shown in FIG. 8, example 800 may include frame exchanges to enable master AP 802 to coordinate with slave AP 804 to perform specific multi-AP transmission schemes with their associated STAs 806 and 808 respectively. The multi-AP transmission schemes may include COFDMA, CTDMA, CSR, CBF, JT/JR, or a combination of two or more of the aforementioned schemes.

As shown in FIG. 8, master AP 802 may begin example 800 by transmitting a frame 810 to AP 804. Frame 810 may include information related to AP 804 (e.g., an identifier of AP 804), synchronization information, information related to a specific multi-AP transmission scheme to be used, and/or information related to a resource unit (RU) for use by AP 804 to acknowledge frame 810. Frame 810 may comprise a control frame. For example, frame 810 may comprise a multi-AP trigger frame.

Slave AP 804 may receive frame 810 and may use the synchronization information to synchronize with master AP 802. Subsequently, APs 802 and 804 may perform data transmission to their associated STAs 806 and 808 respectively. Specifically, AP 802 may transmit a data frame 812 to its associated STA 806, and AP 804 may transmit a data frame 814 to its associated STA 808. Depending on the multi-AP transmission scheme being used, APs 802 and 804 may transmit frames 812 and 814 respectively to STAs in different BSSs. For example, when the multi-AP transmission scheme is JT/JR, AP 802 may also transmit frame 812 to STA 808 associated with slave AP 804, and AP 804 may also transmit frame 814 to STA 808 associated with AP 804. The resources for transmitting and receiving frames 812 and 814 may depend on the specific multi-AP transmission scheme adopted.

STAs 806 and 808 may acknowledge frames 812 and 814 respectively. For example, STA 806 may transmit a frame 816 to AP 802, and STA 808 may transmit a frame 818 to AP 804. Frames 816 and 818 may comprise block ack (BA) frames. STAs 806 and 808 may also transmit frames 816 and 818 to APs in different BSSs, when required by the used multi-AP transmission scheme. For example, when the multi-AP transmission scheme is JT/JR, STA 806 may also transmit frame 816 to AP 804, and STA 808 may also transmit frame 818 to AP 802. The resources for transmitting and receiving frames 816 and 818 may depend on the specific multi-AP transmission scheme adopted.

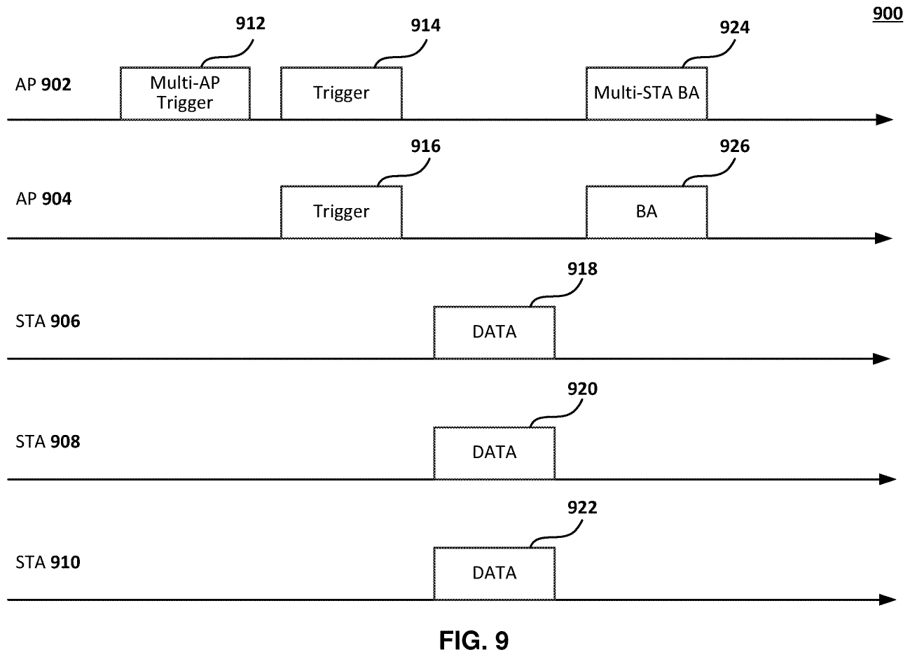

FIG. 9 illustrates an example 900 of a multi-AP uplink data transmission phase. Example 900 may be an example of multi-AP data transmission phase 616. As shown in FIG. 9, example 900 may include a master AP 902 and a slave AP 904 of a multi-AP group. Example 900 may further include STAs 906 and 908 associated with AP 902, and a STA 910 associated with AP 904.

As shown in FIG. 9, example 900 may include frame exchanges to enable master AP 902 to coordinate with slave AP 904 to perform specific multi-AP transmission schemes with STAs 906, 908, and 910910. The multi-AP transmission schemes may include COFDMA, CTDMA, CSR, CBF, JT/JR, or a combination of two or more of the aforementioned schemes.

As shown in FIG. 9, master AP 902 may begin example 900 by transmitting a frame 912 to AP 904. Frame 912 may include information related to AP 904 (e.g., an identifier of AP 904), synchronization information, information related to a specific multi-AP transmission scheme to be used, and/or information related to an RU for use by AP 904 to acknowledge frame 912. Frame 912 may comprise a control frame. For example, frame 912 may comprise a multi-AP trigger frame.

Slave AP 904 may receive frame 912 and may use the synchronization information to synchronize with master AP 902. Subsequently, APs 902 and 904 may solicit uplink data transmissions from their associated STAs 906, 908 and 910 using trigger frames. Specifically, AP 902 may transmit a trigger frame 914 to its associated STAs 906 and 908, and AP 904 may transmit a trigger frame 916 to its associated STA 910. Depending on the multi-AP transmission scheme being used, APs 902 and 904 may also transmit frames 914 and 916 respectively to STAs in different BSSs. For example, when the multi-AP transmission scheme is JT/JR, AP 902 may also transmit frame 914 to STA 910 associated with slave AP 904, and AP 904 may also transmit frame 916 to STAs 906 and 908 associated with AP 902. The resources for transmitting and receiving frames 914 and 916 may depend on the specific multi-AP transmission scheme adopted.

STAs 906 and 908 may respond to frame 914, STA 910 may respond to frame 916. For example, STAs 906 and 908 may transmit frames 918 and 920 respectively to AP 902, while STA 910 may transmit a frame 922 to AP 904. Frames 918, 920, and/or 922 may be transmitted simultaneously. Frames 918, 920, and 922 may comprise data frames or null data frames. STAs 906, 908, and 910 may also transmit frames 918, 920, and 922 respectively to APs in different BSSs, when required by the used multi-AP transmission scheme. For example, when the multi-AP transmission scheme is JT/JR, STAs 906 and 908 may also transmit respective frames 918 and 920 to AP 904, and STA 910 may also transmit frame 922 to AP 902. The resources for transmitting and receiving frames 918, 920, and 922 may depend on the specific multi-AP transmission scheme adopted. AP 902 may acknowledge frames 918 and 920 by transmitting a multi-STA BA frame 924 to STAs 906 and 908. AP 904 may acknowledge frame 922 by transmitting a BA frame 926 to STA 910.

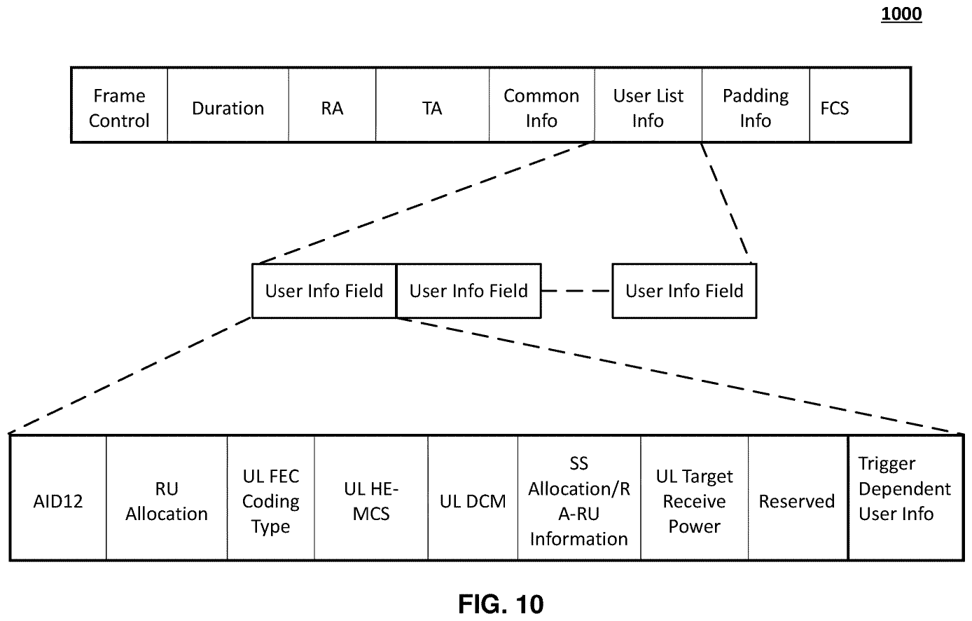

FIG. 10 illustrates an example trigger frame 1000. Trigger frame 1000 may correspond to a basic trigger frame as defined in the existing IEEE 802.11ax standard amendment. Trigger frame 1000 may be used by an AP to allocate resources for and solicit one or more TB PPDU transmissions from one or more STAs. Trigger frame 1000 may also carry other information required by a responding STA to transmit a TB PPDU to the AP.

As shown in FIG. 10, trigger frame 1000 includes a Frame Control field, a Duration field, a receiver address (RA) field, a transmitter address (TA) field, a Common Info field, a User List Info field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 1000 if trigger frame 1000 is addressed to STAs that belong to a single BSS. The TA field is the transmitted BSSID if the trigger frame 1000 is addressed to STAs from at least two different BSSs of the multiple BSSID set.

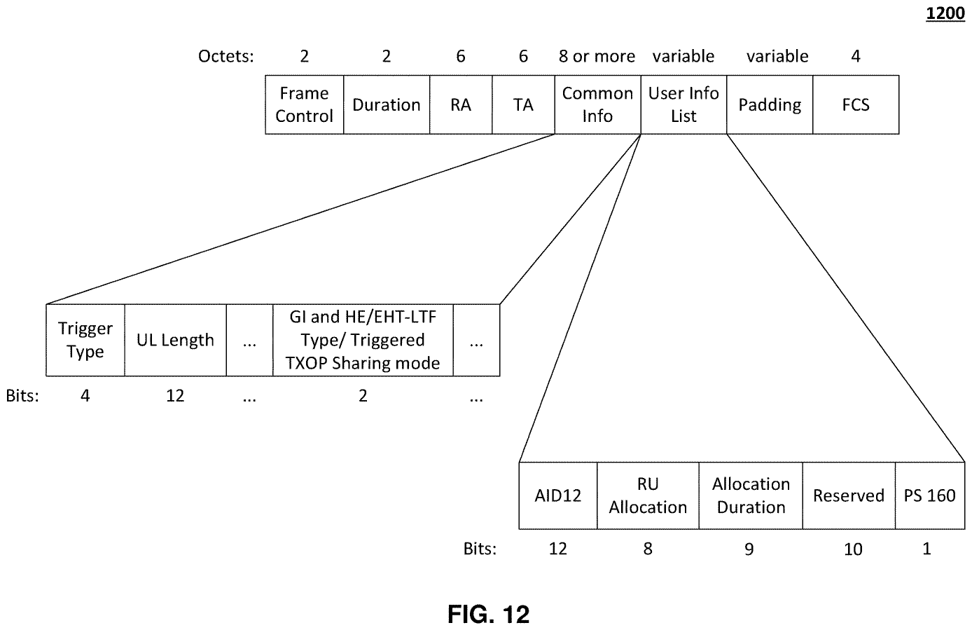

The common info field may have a format as illustrated by the common info field shown in FIG. 12. The common info field specifies a trigger frame type of trigger frame 1000, a transmit power of trigger frame 1000 in dBm, and several key parameters of a TB PPDU that is transmitted by a STA in response to trigger frame 1000. The trigger frame type of a trigger frame used by an AP to receive QoS data using UL MU operation is referred to as a basic trigger frame.

The User List Info field contains a User Info field per STA addressed in trigger frame 1000. The per STA User Info field includes, among others, an AID subfield, an RU Allocation subfield, a Spatial Stream (SS) Allocation subfield, an MCS subfield to be used by a STA in a TB PPDU transmitted in response to trigger frame 1000, and a Trigger Dependent User Info subfield. The Trigger Dependent User Info subfield can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA.

The Padding field is optionally present in trigger frame 1000 to extend the frame length to give recipient STAs enough time to prepare a response for transmission one SIFS (short interframe spacing) after the frame is received. The Padding field, if present, is at least two octets in length and is set to all 1s.

The FCS field is used by a STA to validate a received frame and to interpret certain fields from the MAC headers of a frame.

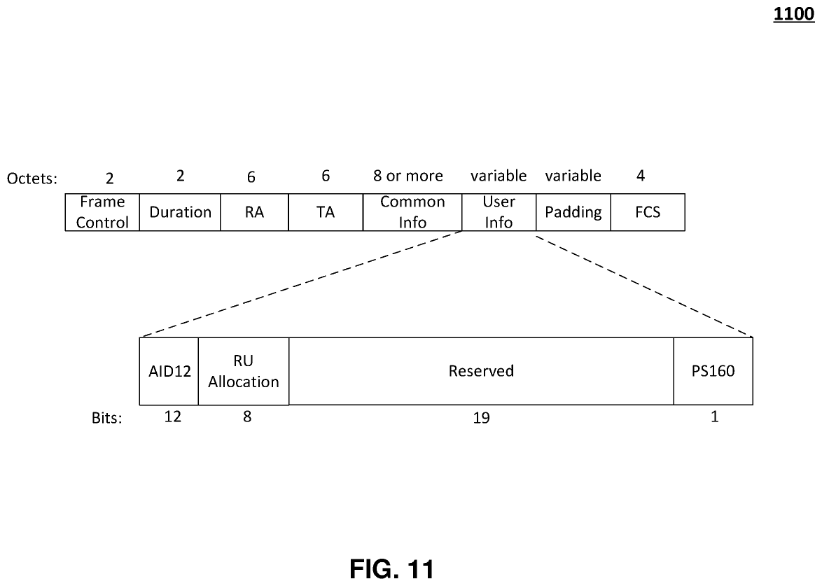

FIG. 11 illustrates an example multi-user request to send (MU-RTS) trigger frame 1100. MU-RTS trigger frame 1100 may be used by an AP to solicit simultaneous CTS frames from multiple STAs to transmit a downlink (DL) MU PPDU to the multiple STAs. As shown in FIG. 11, MU-RTS trigger frame 1100 may comprise a frame control field, a duration field, an RA field, a TA field, a common info field, one or more user info fields, a padding field, and an FCS field. The frame control, TA, RA, padding, and FCS fields may be similar to the corresponding fields of trigger frame 1000 described above. The common info field may have a format as illustrated by the common info field shown in FIG. 12. The duration field may be set to the time, in microseconds, required to transmit the DL MU PPDU, plus the time required to transmit one CTS frame, one ACK frame (if required), and three SIFS periods.

The one or more user info fields correspond respectively to the one or more STAs solicited by MU-RTS trigger frame 1100. As shown in FIG. 11, a user info field may comprise an AID12 subfield, an RU allocation subfield, reserved bits, and a PS 160 subfield. The AID12 subfield comprises an association identifier of the STA to which the user info field is addressed. The RU allocation subfield indicates a channel on which the solicited STA is to transmit the CTS frame. In an example, this may include a primary 20 MHz channel, a primary 40 MHz, a primary 80 MHz channel, a primary 160 MHz, an 80 +80 Mhz channel, or a 320 MHz channel.

FIG. 12 illustrates an example of a MRTT frame 1200 which may be used in a TXS procedure. As shown in FIG. 12, example MRTT frame 1200 may comprise a frame control field, a duration field, a receiver address (RA) field, a transmitter address (TA) field, a common info field, a user info list field, a padding field, and/or frame check sequence (FCS) field.

In an example, the common info field may be a high-efficiency (HE) variant common info field or an extremely high throughput (EHT) variant common info field. An EHT variant common info field may comprise, as shown in FIG. 12, one or more of the following subfields: trigger type, UL length, more TF, CS required, UL BW, GI and HE/EHT-LTF Type/Triggered TXOP sharing mode, number of HE/EHT-LTF symbols, LDPC extra symbol segment, AP Tx Power, Pre-FEC padding factor, PE disambiguity, UL spatial reuse, HE/EHT P160, special user info field flag, EHT reserved, reserved, or trigger dependent common info.

The trigger type subfield indicates that frame 1200 is an MRTT frame.

The GI and HE/EHT-LTF Type/Triggered TXOP sharing mode subfield may include a triggered TXOP sharing mode subfield. In an example, the triggered TXOP sharing mode subfield may be set to a non-zero value (e.g., 1 or 2). In an example, the triggered TXOP sharing mode subfield may be set to 1. As such, the triggered TXOP sharing mode subfield may indicate that a STA indicated by an AID12 subfield of a user info field (of the user info list field) may transmit one or more non-TB PPDUs to the AP during a time indicated in the allocation duration subfield of the user info field. In another example, the triggered TXOP sharing mode subfield may be set to 2. As such, the triggered TXOP sharing mode subfield may indicate that a STA indicated by an AID12 subfield of a user info field (of the user info list field) may transmit one or more non-TB PPDUs to the AP or to a peer STA during the time indicated by the allocation duration subfield of the user info field. In an example, the peer STA may be a STA with a connection for P2P communication or direct communication with the STA.

The user info list field may include one or more user info fields. In an example, an EHT variant user info field may comprise, as shown in FIG. 12, one or more of the following subfields: AID12, RU allocation, allocation duration, reserved, or PS160.

The AID12 subfield may indicate an association identifier (AID) of a STA that may use a time indicated by the allocation duration subfield.

The RU allocation subfield may indicate the location and size of the RU allocated for a STA indicated by the AID12 subfield.

The allocation duration subfield may indicate a time allocated by an AP transmitting MRTT frame 1200. The allocated time may be a portion a TXOP obtained by the AP. In an example embodiment, the allocation duration subfield may indicate a first time period.

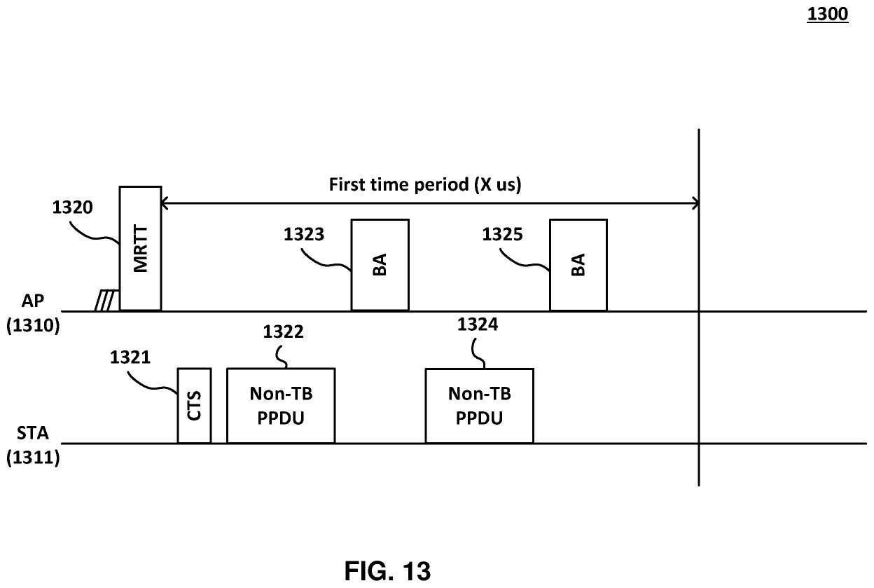

FIG. 13 illustrates an example 1300 of a TXS procedure (Mode=1). As shown in FIG. 13, the TXS procedure may begin by an AP 1310 transmitting an MRTT frame 1320 to a STA 1311. MRTT frame 1320 may allocate a portion of a TXOP obtained by AP 1310 to STA 1311 and may indicate a TXS mode equal to 1. STA 1311 receiving MRTT frame 1320 may use the allocated time to transmit one or more non-TB PPDUs to AP 1310. The one or more non-TB PPDUs may comprise a data frame, a control frame, a management frame, or an action frame.

In an example, MRTT frame 1320 may comprise a triggered TXOP sharing mode subfield that indicates the TXS mode and/or subfield that indicates a first time period corresponding to the allocated time. In an example, the first time period may be set to a value of X microseconds (us).

STA 1311 may respond to MRTT frame 1320 by transmitting a CTS frame 1321 to AP 1310. Subsequently, STA 1311 may transmit non-TB PPDUs 1322, 1324 comprising one or more data frame to AP 1310 during the first time period indicated in MRTT frame 1320. In an example, AP 1310 may transmit one or more Block Ack (BA) frames 1323, 1325 in response to the one or more data frames contained in non-TB PPDUs 1322, 1324 received from STA 1311.

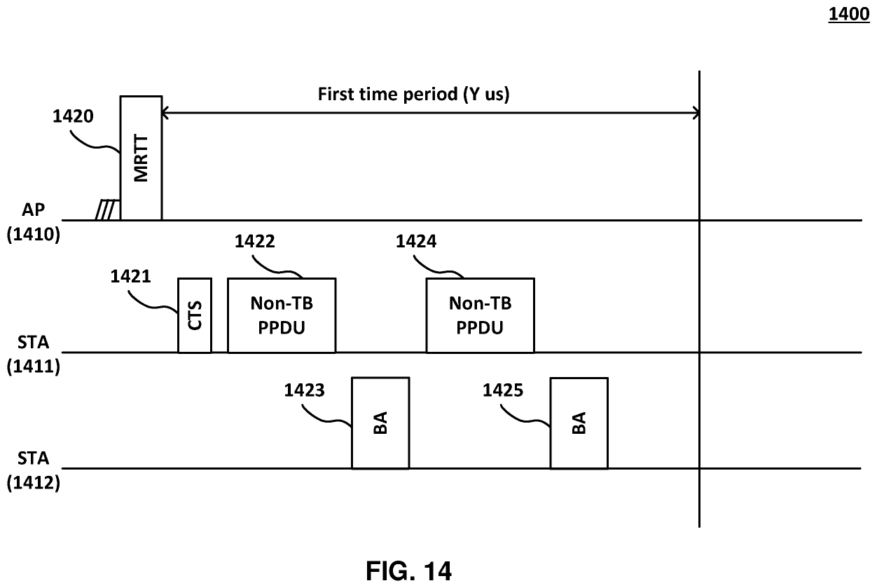

FIG. 14 illustrates an example 1400 of a TXS procedure (Mode=2). As shown in FIG. 14, the TXS procedure may begin with an AP 1410 transmitting an MRTT frame 1420 to a STA 1411. MRTT frame 1420 may allocate a portion of a TXOP obtained by AP 1410 to STA 1411 and may indicate a TXS mode equal to 2. STA 1411 receiving MRTT frame 1420 may use the allocated time to transmit one or more non-TB PPDUs to STA 1412. The one or more non-TB PPDUs may comprise a data frame, a control frame, a management frame, or an action frame.

In an example, MRTT frame 1420 may comprise a triggered TXOP sharing mode subfield that indicates the TXS mode and/or subfield that indicates a first time period corresponding to the allocated time. In an example, the first time period may be set to a value of Y microseconds (us).

STA 1411 may respond to MRTT frame 1420 by transmitting a CTS frame 1421 to AP 1410. Subsequently, STA 1411 may transmit non-TB PPDUs 1422, 1424 comprising one or more data frame to STA 1412 during the first time period indicated in MRTT frame 1420. In an example, STA 1412 may transmit one or more BA frames 1423, 1425 in response to the one or more data frames contained in non-TB PPDUs 1422, 1424 received from STA 1411.

In CTDMA, one approach for TXOP sharing may be achieved via the TXS procedure described above. The TXS procedure may be used to allow a sharing AP, which obtains a TXOP and is the TXOP owner, to allocate a time duration within its obtained TXOP to a shared AP for downlink and/or uplink transmission between the shared AP and its associated STAs.

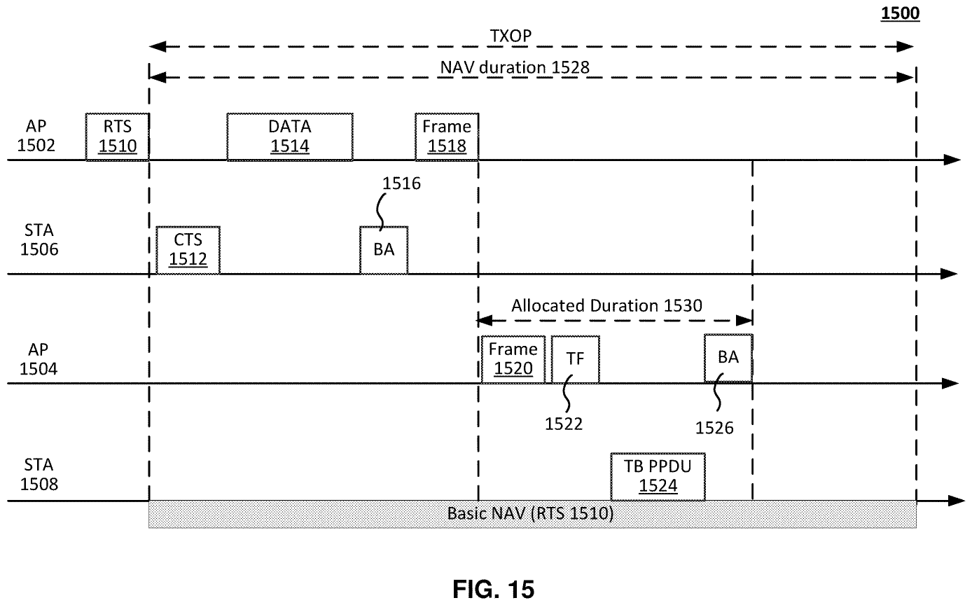

FIG. 15 illustrates an example 1500 of an existing CTDMA procedure. As shown in FIG. 15, example 1500 includes an AP 1502, an AP 1504, a STA 1506, and a STA 1508. APs 1502 and 1504 may form a coordinated AP set or may form part of a multi-AP group. AP 1502 may be the master or sharing AP and AP 1504 may be the slave or shared AP. STA 1506 may be associated with AP 1502 and STA 1508 may be associated with AP 1504.

As shown in FIG. 15, example 1500 may begin with AP 1502 gaining access to the shared channel and transmitting a request to send (RTS) frame 1510 to STA 1506. RTS frame 1510 initiates a TXOP obtained by AP 1502. The TXOP may have a duration, subject to a TXOP limit, during which AP 1502, the TXOP holder, maintains uninterrupted control of the shared channel. RTS frame 1510 may include a duration field (e.g., Duration/ID field) that indicates a NAV duration 1528. The duration field may be used by a receiving STA to set a NAV, based on NAV duration 1528, that prevents the receiving STA from transmitting during NAV duration 1528. AP 1502 may set the duration field of RTS frame 1510 to protect one or more frames following RTS frame 1510. In example 1500, AP 1502 sets the duration field of RTS frame 1510 such that NAV duration 1528 corresponds to the duration of the TXOP. As such, AP 1502 protects any frame transmission that occurs during the TXOP.

On receiving RTS frame 1510 from AP 1502, STA 1506 transmits a CTS frame 1512 to AP 1502. CTS frame 1512 may also include a duration field (e.g., Duration/ID field) that indicates a NAV duration (not shown in FIG. 15). The NAV duration indicated in CTS frame 1512 may correspond to a remaining duration of NAV duration 1528 (e.g., NAV duration 1528, minus the duration of a SIFS between RTS frame 1510 and CTS frame 1512, minus the transmission duration of CTS frame 1512). On receiving CTS frame 1512 from STA 1506, AP 1502 initiates transmission of a data frame 1514 to STA 1506. STA 1506 acknowledges reception of data frame 1514 by transmitting a BA frame 1516 to AP 1502.

Subsequently, AP 1502, as the holder of the TXOP, may decide to share a portion of the remainder of the TXOP with AP 1504. As such, as shown in FIG. 15, AP 1502 transmits a frame 1518 that allocates a duration 1530 of the TXOP to AP 1504. Frame 1518 may be a multi-AP MRTT frame. In an implementation, on receiving frame 1518 from AP 1502, AP 1504 may be configured to transmit a frame 1520 accepting allocated duration 1530. Frame 1520 may be a clear to send (CTS) frame. Subsequently, AP 1504 may use allocated duration 1530 to transmit downlink data and/or receive uplink data to/from one or more associated STAs. For instance, in example 1500, AP 1504 uses allocated duration 1530 to send a trigger frame 1522 to STA 1508. Trigger frame 1522 allocates uplink resource units (RUs) to STA 1508. In response to trigger frame 1522, STA 1508 transmits a trigger-based (TB) PPDU 1524 using the allocated uplink RUs to AP 1504. AP 1504 may acknowledge TB PPDU 1524 by transmitting a BA frame 1526 to STA 1508.

A problem, however, may arise in the CTDMA procedure of FIG. 15 when STA 1508 happens to be within the communication range of AP 1502. Specifically, when in the communication range of AP 1502, STA 1508 may hear RTS frame 1510 and may set its basic NAV (or inter-BSS NAV) according to NAV duration 1528 indicated in the duration field of RTS frame 1510. As a result, STA 1508 may refrain from any transmission during NAV duration 1528, and, specifically, may not respond to trigger frame 1522 from AP 1504. AP 1504 may thus fail to use allocated duration 1530 for communication with STA 1508, leading to channel resources being wasted.

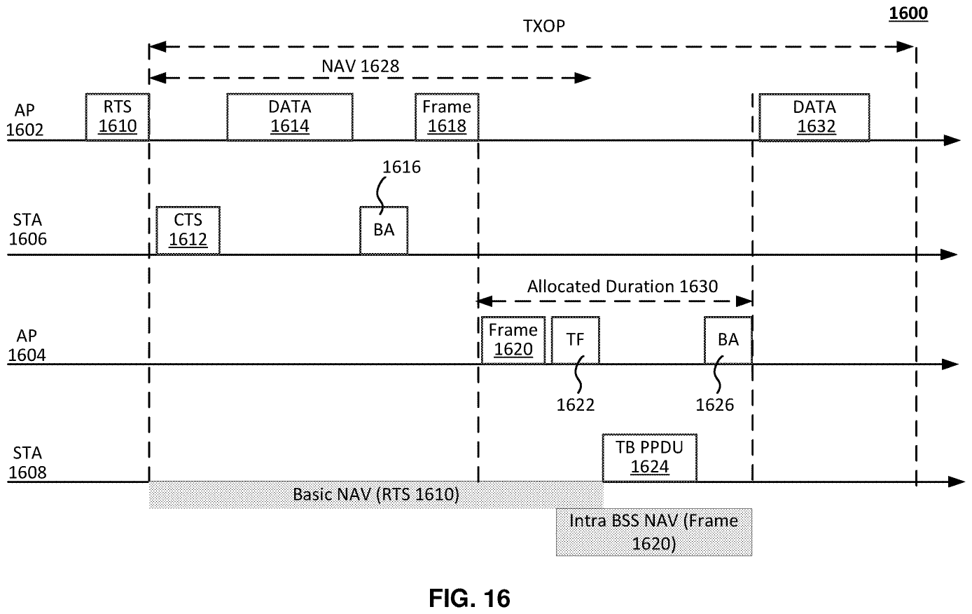

To mitigate this problem, incremental TXOP protection has been proposed. FIG. 16 illustrates an example 1600 of an existing CTDMA procedure using incremental TXOP protection. As shown in FIG. 16, example 1600 includes an AP 1602, an AP 1604, a STA 1606, and a STA 1608. APs 1602 and 1604 may form a coordinated AP set or may form part of a multi-AP group. AP 1602 may be the master or sharing AP and AP 1604 may be the slave or shared AP. STA 1606 may be associated with AP 1602 and STA 1608 may be associated with AP 1604.

Like example 1500, example 1600 may also begin with AP 1602 gaining access to the shared channel and transmitting an RTS frame 1610 to STA 1606. RTS frame 1610 may be similar to RTS frame 1510 described above. However, unlike RTS frame 1510, in which the duration field (e.g., Duration/ID field) is set to the duration of the TXOP, in RTS frame 1610, the duration field is set to a NAV duration 1628 that is only a portion of the duration of the TXOP. For example, AP 1602 may select NAV duration 1628 to correspond to an estimated time required for the transmission of one or more frames after RTS frame 1610. For instance, in example 1600, knowing an amount of buffered downlink traffic to STA 1606 and wishing to share a portion of the remainder of the TXOP with AP 1604, AP 1602 sets NAV duration 1628 to correspond to the estimated time required for the transmission of a CTS frame 1612 by STA 1606 to AP 1602, a data frame 1614 by AP 1602 to STA 1606, and a BA frame 1616 by STA 1606 to AP 1602, followed by a frame 1618 by AP 1602 to AP 1604, a frame 1620 by AP 1604 to AP 1602, and a trigger frame 1622 by AP 1604 to STA 1608. The estimated time may include any interframe space between successive frames.

On receiving RTS frame 1610, STA 1608 sets its basic NAV according to NAV duration 1628. STA 1608 may refrain from transmitting on the shared channel as long as its basic NAV is non-zero, e.g., until the end of NAV duration 1628.

On receiving RTS frame 1610 from AP 1602, STA 1606 transmits CTS frame 1612 to AP 1602. CTS frame 1612 may also include a duration field (e.g., Duration/ID field) that indicates a NAV duration (not shown in FIG. 16). The NAV duration indicated in CTS frame 1612 may correspond to a remaining duration of NAV duration 1628 (e.g., NAV duration 1628, minus the duration of a SIFS between RTS frame 1610 and CTS frame 1612, minus the transmission duration of CTS frame 1612). On receiving CTS frame 1612 from STA 1606, AP 1602 initiates transmission of data frame 1614 to STA 1606. STA 1606 acknowledges reception of data frame 1614 by transmitting BA frame 1616 to AP 1602.

Subsequently, AP 1602 transmits frame 1618 to allocate a duration 1630 of the TXOP to AP 1604. Frame 1618 may be a multi-AP MRTT frame. In an implementation, on receiving frame 1618 from AP 1602, AP 1604 may be configured to transmit frame 1620 accepting allocated duration 1630. Frame 1620 may be a CTS frame. In an implementation, frame 1620 may include a duration field that indicates a NAV duration (not shown in FIG. 16). On receiving frame 1620 from AP 1604, STA 1608 may set an intra-BSS NAV based on the NAV duration indicated in frame 1620. In an example, STA 1608 may set the intra-BSS NAV based on frame 1620 having a receiver address (RA), a transmitter address (TA), or a basic service set identifier (BSSID) field value that is equal to the BSSID of the BSS or the BSSID of any BSS with which STA 1608 is associated (e.g. AP 1604). With its intra-BSS NAV set to a non-zero value, STA 1608 may not transmit on the shared channel unless triggered by AP 1604. Other STAs not belonging to the BSS of AP 1604 (e.g., AP 1602 or STA 1606) may set their basic NAVs based on the NAV duration indicated in frame 1620. As such, frame 1620 may provide an incremental TXOP protection that extends the initial TXOP protection provided by RTS frame 1610.

Subsequently, AP 1604 may use allocated duration 1630 to transmit downlink data and/or receive uplink data to/from one or more associated STAs. For instance, in example 1600, AP 1604 uses allocated duration 1630 to send trigger frame 1622 to STA 1608. As NAV duration 1628 does not extend beyond trigger frame 1622, STA 1608 may have a basic NAV equal to zero when it receives trigger frame 1622. As such, STA 1608 may be able to respond to trigger frame 1622 by transmitting a TB PPDU 1624 to AP 1604. AP 1604 may acknowledge TB PPDU 1624 by transmitting a BA frame 1626 to STA 1608.

At the end of allocated duration 1630, or earlier in case AP 1604 returns the TXOP to AP 1602 before the end of allocated duration 1630, AP 1602 may regain control of the TXOP as its basic NAV (set due to frame 1620) will be zero allowing it to access the shared channel. For example, as shown in FIG. 16, AP 1602 may regain control of the TXOP by transmitting a data frame 1632 to STA 1606.

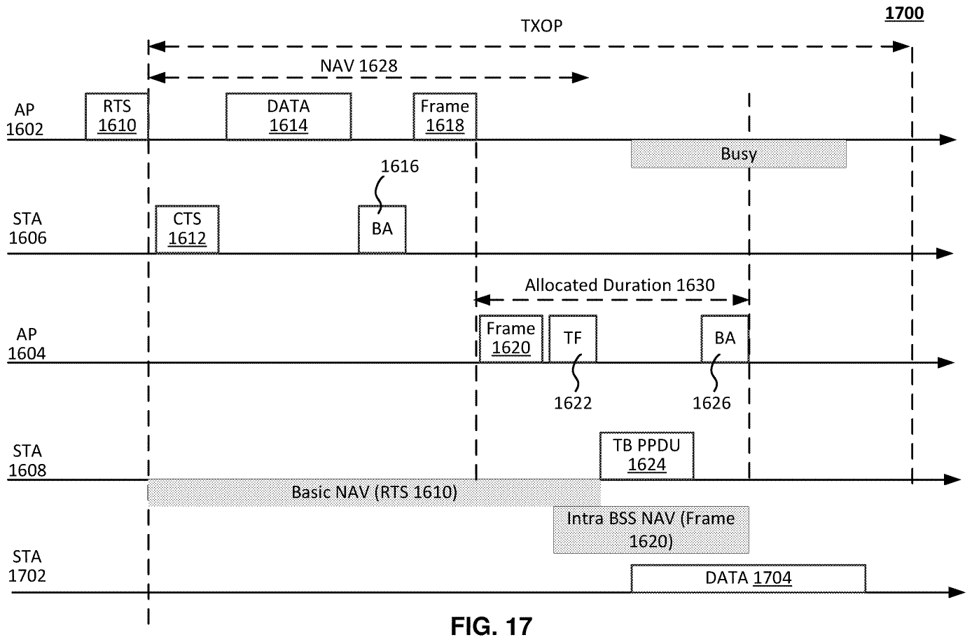

However, in some scenarios, incremental TXOP protection as described in FIG. 16 may fail to fully protect all communications during the TXOP and may not ensure that AP 1602 can regain control of the TXOP after allocated duration 1630. For instance, in example 1700 illustrated in FIG. 17, a STA 1702, which may be associated with AP 1602, may be outside of the communication of range of AP 1604 and STA 1608. STA 1702 may thus not hear frame 1620 and may not set its basic NAV based on the NAV duration indicated in frame 1620. STA 1702 may thus access the shared channel to transmit a data frame 1704 to AP 1602, for example, during allocated duration 1630. Data frame 1704 may interfere with the transmission of TB PPDU 1624 and/or BA frame 1626. More importantly, if the transmission of data frame 1704 extends beyond allocated duration 1630, AP 1602 may not be able to regain control of the TXOP at the end of allocated duration 1630.

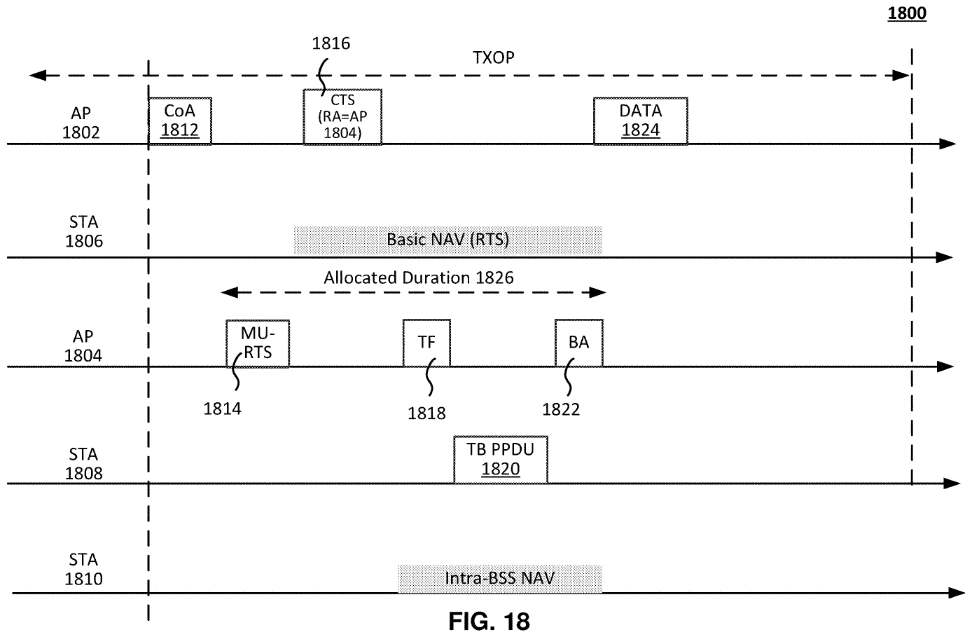

In US 2021/0120548A 1 , Chen et al. describes a CTDMA procedure that is purported to solve the problem illustrated in FIG. 17. FIG. 18 illustrates an example 1800 of Chen's CTDMA procedure. As shown in FIG. 18, example 1800 includes an AP 1802, an AP 1804, a STA 1806, a STA 1808, and a STA 1810. APs 1802 and 1804 may form a coordinated AP set or may form part of a multi-AP group. AP 1802 may be the master or sharing AP and AP 1804 may be the slave or shared AP. STAs 1806 and 1810 may be associated with AP 1802 and STA 1808 may be associated with AP 1804. It is assumed in example 1800 that STA 1810 is outside the communication range of AP 1804 and STA 1808.

In example 1800, AP 1802 may obtain a TXOP and may wish to allocate a duration 1826 of the TXOP to AP 1804. Rather than using a multi-AP MRTT frame to allocate duration 1826 to AP 1804, AP 1802 transmits a coordinated announcement (CoA) frame 1812 to AP 1804. In addition to indicating allocated duration 1826, CoA frame 1812 instructs AP 1804 to respond to CoA frame 1812 by transmitting a specific control frame (e.g., MU-RTS frame) as the first frame of allocated duration 1826, in order to accept allocated duration 1826.

On receiving CoA frame 1812 and wishing to accept allocated duration 1826, AP 1804 transmits an MU-RTS frame 1814 to AP 1802. MU-RTS frame 1814 may indicate a NAV duration corresponding to the remaining duration of allocated duration 1826. STA 1806, associated with AP 1802, may hear MU-RTS frame 1814 and may set its basic NAV based on the NAV duration indicated in MU-RTS frame 1814.

On receiving MU-RTS frame 1814, AP 1802 transmits a CTS frame 1816. CTS frame 1816 may indicate a NAV duration corresponding to the remaining duration of allocated duration 1826. CTS frame 1816 may have a receiver address (RA) field set to the address of AP 1804, allowing AP 1804 to ignore the NAV duration indicated in CTS frame 1816. However, as shown in FIG. 18, CTS frame 1816 may cause STA 1810 to set its intra-BSS NAV for the remaining during of allocated duration 1826. As such, although STA 1810 may be outside the communication range of AP 1804 and STA 1808, STA 1810 may not access the shared channel during allocated duration 1826 and may not interfere with the communication between AP 1804 and STA 1808.

Subsequently, AP 1804 may transmit a trigger frame 1818 to STA 1808 allocating uplink RUs to STA 1808. STA 1808 may respond to trigger frame 1818 by transmitting a TB PPDU 1820 to AP 1804. AP 1804 may acknowledge TB PPDU 1820 by transmitting a BA frame 1822 to STA 1808. At the end of allocated duration 1826, or earlier in case AP 1804 returns the TXOP to AP 1802 before the end of allocated duration 1826, AP 1802 may regain control of the TXOP without being impeded by STA 1810 which remains silent during allocated duration 1826. For example, as shown in FIG. 18, AP 1802 may regain control of the TXOP by transmitting a data frame 1824 to STA 1806.

A disadvantage of Chen's procedure, however, is that it requires a new TXOP sharing procedure. This new TXOP sharing procedure requires the creation of a new control frame (CoA frame) for a sharing AP to allocate a duration of its TXOP to a shared AP. Further, the new control frame is designed to trigger a new behavior by the shared AP, which includes sending an MU-RTS frame to accept the allocated duration.

Embodiments of the present disclosure, as further described below, address the above-described problems of existing CTDMA procedures. In particular, embodiments provide TXS-based TXOP sharing solutions with incremental TXOP protection that solve the problem of a sharing AP losing control of its TXOP after an allocated duration. By using TXS-based TXOP sharing, the proposed solutions can be implemented with minimal modifications to existing IEEE 802.11 standard procedures and control frames. This has the advantage of improved backward and forward computability and of lower implementation complexity. In one aspect, a first AP transmits to a second AP, during a TXOP obtained by the first AP, a first frame comprising: an allocation duration field indicating a first duration, within the TXOP, allocated to the second AP; and an indication of a transmission by the first AP of a second frame within the first duration. The first AP receives from the second AP, and during the first duration, a third frame comprising a duration field indicating a second duration overlapping the first duration. The second duration may be a NAV duration to protect communication by the second AP after the third frame. The first AP transmits the second frame during the second duration. The second frame may include a duration field indicating a third duration overlapping the first duration. The third duration may be a NAV duration and may extend to an end of the first/second duration. This may cause one or more STAs to remain silent during the first/second duration, ensuring protection of the communication by the second AP during the second duration and return of TXOP control to the first AP after the first duration.

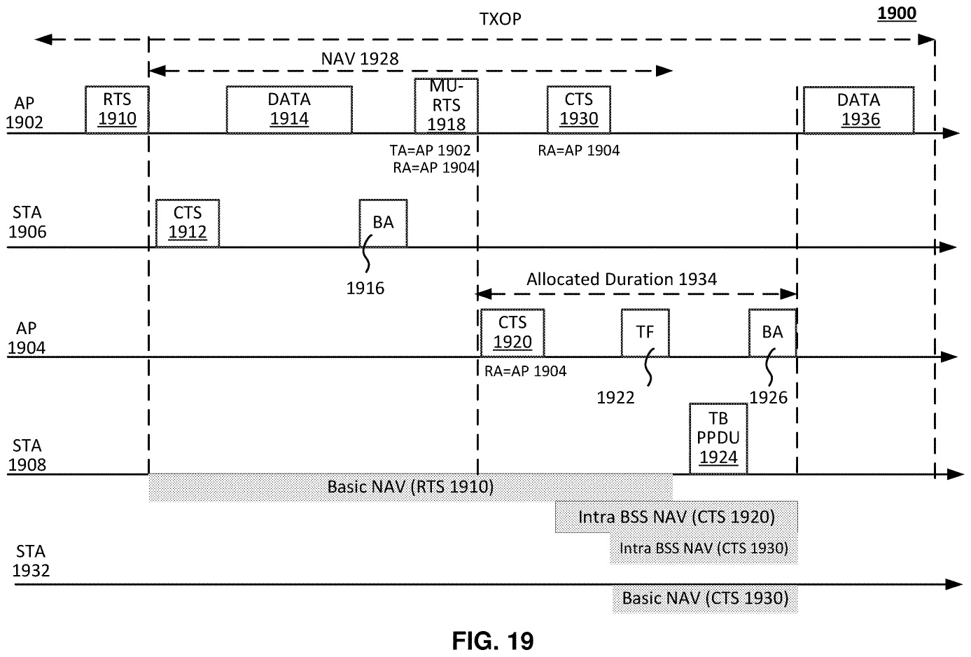

FIG. 19 illustrates an example 1900 of a CTDMA procedure according to an embodiment. As shown in FIG. 19, example 1900 includes an AP 1902, an AP 1904, a STA 1906, a STA 1908, and a STA 1932. APs 1902 and 1904 may form a coordinated AP set or may form part of a multi-AP group. AP 1902 may be the master or sharing AP and AP 1904 may be the slave or shared AP. STAs 1906 and 1932 may be associated with AP 1902 and STA 1908 may be associated with AP 1904.

As shown in FIG. 19, example 1900 may begin with AP 1902 gaining access to the shared channel and transmitting an RTS frame 1910 to STA 1906. RTS frame 1910 may be similar to RTS frame 1510 described above. However, unlike RTS frame 1510, in which the duration field (e.g., Duration/ID field) is set to the duration of the TXOP, in RTS frame 1910, the duration field is set to a NAV duration 1928 that is only a portion of the duration of the TXOP. For example, AP 1902 may select NAV duration 1928 to correspond to an estimated time required for the transmission of one or more frames after RTS frame 1910. For instance, in example 1900, knowing an amount of buffered downlink traffic to STA 1906 and wishing to share a portion of the remainder of the TXOP with AP 1904, AP 1902 sets NAV duration 1928 to correspond to the estimated time required for the transmission of a CTS frame 1912 by STA 1906 to AP 1902, a data frame 1914 by AP 1902 to STA 1906, and a BA frame 1916 by STA 1906 to AP 1902, followed by an MU-RTS (or an MRTT) frame 1918 by AP 1902 to AP 1904, a CTS frame 1920 by AP 1904 to AP 1902, a CTS frame 1930 by AP 1902 to AP 1904, and a trigger frame 1922 by AP 1904 to STA 1908. The estimated time may include any interframe space between successive frames. In other embodiments, however, AP 1902 may set NAV duration 1928 to be longer or shorter than in example 1900.

On receiving RTS frame 1910, STA 1908 sets its basic NAV according to NAV duration 1928. STA 1908 may refrain from transmitting on the shared channel as long as its basic NAV is non-zero, e.g., until the end of NAV duration 1928.

On receiving RTS frame 1910 from AP 1902, STA 1906 transmits CTS frame 1912 to AP 1902. CTS frame 1912 may also include a duration field (e.g., Duration/ID field) that indicates a NAV duration (not shown in FIG. 19). The NAV duration indicated in CTS frame 1912 may correspond to a remaining duration of NAV duration 1928 (e.g., NAV duration 1928, minus the duration of a SIFS between RTS frame 1910 and CTS frame 1912, minus the transmission duration of CTS frame 1912). On receiving CTS frame 1912 from STA 1906, AP 1902 initiates transmission of data frame 1914 to STA 1906. STA 1906 acknowledges reception of data frame 1914 by transmitting BA frame 1916 to AP 1902. In an embodiment, RTS frame 1910 and CTA frame 1912 may be replaced by an initial control frame (ICF) and an initial control response (ICR) frame respectively. In an embodiment, the ICF may be a control frame transmitted by an AP (e.g., AP 1902) at the beginning of a TXOP of the AP to announce its intention to share a portion of the TXOP.

Subsequently, AP 1902 transmits MU-RTS (or MRTT) frame 1918 to allocate a duration 1934 of the TXOP to AP 1904. In an implementation, a transmitter address (TA) and a receiver address (RA) of MU-RTS (or MRTT) frame 1918 are set to AP 1902 and AP 1904, respectively. In an embodiment, MU-RTS (or MRTT) frame 1918 includes an allocation duration field indicating allocated duration 1934. In an implementation, MU-RTS (or MRTT) frame 1918 triggers transmission of CTS frame 1920 by AP 1904, e.g., a SIFS after reception of MU-RTS (or MRTT) frame 1918 by AP 1904. In an embodiment, MU-RTS (or MRTT) frame 1918 further includes an indication of a transmission, by AP 1902, of a frame within allocated duration 1934. In an implementation, the frame to be transmitted by AP 1902 within allocated duration 1934 may be CTS frame 1930, transmitted after (e.g., a SIFS after) CTS frame 1920. The indication of the transmission of the frame by AP 1902 may thus indicate to AP 1904 that AP 1902 will transmit CTS frame 1930 after AP 1904 transmits CTS frame 1920. This configures AP 1904 to wait for the transmission of CTS frame 1930 by AP 1902, before proceeding to use allocated duration 1934 for communication with its associated STAs. In an implementation, the indication may be provided in a common info field or in a user info field of MU-RTS (or MRTT) frame 1918.

In another embodiment, MU-RTS (or MRTT) frame 1918 may include a duration field (e.g., Duration/ID field) that indicates a NAV duration (not shown in FIG. 19). The NAV duration indicated in MU-RTS (or MRTT) frame 1918 may correspond to a duration that overlaps allocated duration 1934 (e.g., allocated duration 1934, minus the transmission duration of MU-RTS (or MRTT) frame 1918). In an implementation, AP 1902 may choose to set the NAV duration to overlap allocated duration 1934 based on its knowledge that AP 1904 intends to use allocated duration 1934. For example, AP 1902 may have knowledge that AP 1904 intends to transmit CTS frame 1920, e.g., a SIFS after MU-RTS (or MRTT) frame 1918. In an implementation, a frame exchange between AP 1902 and AP 1904 (not shown in FIG. 19) may take place before AP 1902 transmits MU-RTS frame 1918. The frame exchange may include a buffer status report poll (BSRP) frame from AP 1902 to AP 1904 and a buffer status report (BSR) frame from AP 1904 to AP 1902. Based on the frame exchange, AP 1902 may determine whether AP 1904 intends to use allocated duration 1934.

On receiving MU-RTS (or MRTT) frame 1918 from AP 1902, AP 1904 may be configured to transmit CTS frame 1920. In an embodiment, MU-RTS (or MRTT) frame 1918 triggers or solicits CTS frame 1920 from AP 1904. In an implementation, CTS frame 1920 may include a duration field that indicates a NAV duration (not shown in FIG. 19). The NAV duration indicated in CTS frame 1920 may overlap with allocated duration 1934. In an implementation, the NAV duration indicated in CTS frame 1920 corresponds to a remaining duration of allocated duration 1934 after CTS frame 1920. In an implementation, a receiver address (RA) of CTS frame 1920 is set to AP 1904.

On receiving CTS frame 1920 from AP 1904, STA 1908 may set an intra-BSS NAV based on the NAV duration indicated in CTS frame 1920. In an example, STA 1908 may set the intra-BSS NAV based on CTS frame 1920 having an RA value that is equal to the BSSID of the BSS or the BSSID of any BSS with which the STA 1908 is associated (e.g. AP 1904). With its intra-BSS NAV set to a non-zero value, STA 1908 may not transmit on the shared channel unless triggered by AP 1904. Other STAs not belonging to the BSS of AP 1904 (e.g., STA 1906) may set their basic NAVs based on the NAV duration indicated in CTS frame 1920. As such, CTS frame 1920 may provide an incremental TXOP protection that extends the initial TXOP protection provided by RTS frame 1910.

In an embodiment, AP 1902 may be configured not to set its basic NAV based on CTS frame 1920. Further, AP 1902 may be configured to transmit CTS frame 1930 in response to CTS frame 1920 (e.g., a SIFS after reception of CTS frame 1920). AP 1904 may not transmit while AP 1902 transmits CTS frame 1930 based on the indication of the transmission by AP 1902 of CTS frame 1930 comprised in MU-RTS (or MRTT) frame 1918. In an embodiment, CTS frame 1930 comprises a duration field indicating a duration that overlaps with allocated duration 1934. In an implementation, the duration corresponds to allocated duration 1934. In an implementation, the duration may be a NAV duration corresponding to the remaining duration of allocated duration 1934. In an implementation, the duration may be a NAV duration corresponding to the NAV duration indicated in CTS frame 1920 by AP 1904.

In an implementation, CTS frame 1930 may comprise an address of AP 1904 and/or a basic service set identifier (BSSID) of a BSS of AP 1904. In an implementation, the address of AP 1904 may be provided in a receiver address (RA) or a transmitter address (TA) of CTS frame 1930. In an implementation, the BSSID of the BSS of AP 1904 may be provided in a BSSID field of CTS frame 1930. Accordingly, a STA receiving a PPDU carrying CTS frame 1930 may classify the received PPDU as originating from the BSS of AP 1904. In particular, in example 1900, STA 1908 may only update its intra-BSS NAV based on CTS frame 1930 and may not set its basic NAV. In contrast, STA 1932, associated with AP 1902, may set its basic NAV, instead of its intra-BSS NAV, for the remaining of allocated duration 1934 based on CTS frame 1930. As such, although STA 1932 may be outside the communication range of AP 1904 and STA 1908, STA 1932 may not access the shared channel during allocated duration 1934 and may not interfere with the communication between AP 1904 and STA 1908.

Subsequently, AP 1904 may use allocated duration 1934 to transmit downlink data and/or receive uplink data to/from one or more associated STAs. For instance, in example 1900, AP 1904 uses allocated duration 1934 to send trigger frame 1922 to STA 1908. As NAV duration 1928 does not extend beyond trigger frame 1922, STA 1908 may have a basic NAV equal to zero when it receives trigger frame 1922. As such, STA 1908 may be able to respond to trigger frame 1922 by transmitting a TB PPDU 1924 to AP 1904. AP 1904 may acknowledge TB PPDU 1924 by transmitting a BA frame 1926 to STA 1908.

At the end of allocated duration 1934, or earlier in case AP 1904 returns the TXOP to AP 1902 before the end of allocated duration 194, AP 1902 may regain control of the TXOP without being impeded by STA 1932 which remains silent during allocated duration 1934. For example, as shown in FIG. 19, AP 1902 may regain control of the TXOP by transmitting a data frame 1936 to STA 1906.

In some cases, AP 1902 may not hear CTS frame 1920 from AP 1904. For example, AP 1904 may not receive CTS frame 1920 due to low SNR or hidden node interference experienced by AP 1902. In another example, AP 1904 may not transmit CTS frame 1920 due AP 1904 failing to receive MU-RTS (or MRTT) frame 1918, e.g., if low SNR or hidden node interference is experienced by AP 1904 while receiving MU-RTS (or MRTT) frame 1918. In some of these cases, AP 1902 may have prior knowledge that AP 1904 is going to utilize allocated duration 1934. In an embodiment, when AP 1902 does not hear CTS frame 1920, instead of transmitting CTS frame 1930, AP 1902 may transmit a CF-END frame (not shown in FIG. 19) to cancel (or reset) the remainder of NAV duration 1928 as indicated in RTS frame 1910 or as extended by MU-RTS (or MRTT) frame 1918 based on the knowledge that AP 1904 is going to utilize allocated duration 1934. In another embodiment, shared APs and their associated STAs (e.g., AP 1904 and STA 1908) may be configured to reset the NAV set by MU-RTS (or MRTT) frame 1918 based on not receiving, within a time out period, a frame following MU-RTS (or MRTT) frame 1918. For example, the shared APs and their associated STAs may reset the NAV based on not receiving a CTS frame (e.g., CTS frame 1920) within a time out period from MU-RTS (or MRTT) frame 1918.

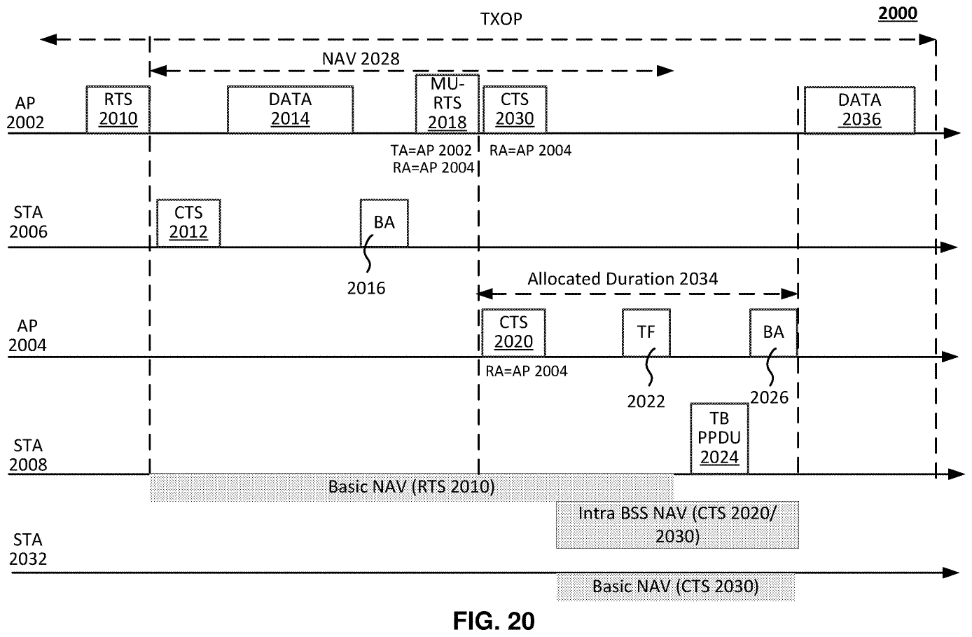

FIG. 20 illustrates an example 2000 of another CTDMA procedure according to an embodiment. As shown in FIG. 20, example 2000 includes an AP 2002, an AP 2004, a STA 2006, a STA 2008, and a STA 2032. APs 2002 and 2004 may form a coordinated AP set or may form part of a multi-AP group. AP 2002 may be the master or sharing AP and AP 2004 may be the slave or shared AP. STAs 2006 and 2032 may be associated with AP 2002 and STA 2008 may be associated with AP 2004.

As shown in FIG. 20, example 2000 may begin with AP 2002 gaining access to the shared channel and transmitting an RTS frame 2010 to STA 2006. RTS frame 2010 may be similar to RTS frame 1510 described above. However, unlike RTS frame 1510, in which the duration field (e.g., Duration/ID field) is set to the duration of the TXOP, in RTS frame 2010, the duration field is set to a NAV duration 2028 that is only a portion of the duration of the TXOP. For example, AP 2002 may select NAV duration 2028 to correspond to an estimated time required for the transmission of one or more frames after RTS frame 2010. For instance, in example 2000, knowing an amount of buffered downlink traffic to STA 2006 and wishing to share a portion of the remainder of the TXOP with AP 2004, AP 2002 sets NAV duration 2028 to correspond to the estimated time required for the transmission of a CTS frame 2012 by STA 2006 to AP 2002, a data frame 2014 by AP 2002 to STA 2006, and a BA frame 2016 by STA 2006 to AP 2002, followed by an MU-RTS (or an MRTT) frame 2018 by AP 2002 to AP 2004, a CTS frame 2020 by AP 2004 to AP 2002 (and a concurrent CTS frame 2030 by AP 2002 to AP 2004), and a trigger frame 2022 by AP 2004 to STA 2008. The estimated time may include any interframe space between successive frames. In other embodiments, however, AP 2002 may set NAV duration 2028 to be longer or shorter than in example 2000.

On receiving RTS frame 2010, STA 2008 sets its basic NAV according to NAV duration 2028. STA 2008 may refrain from transmitting on the shared channel as long as its basic NAV is non-zero, e.g., until the end of NAV duration 2028.

On receiving RTS frame 2010 from AP 2002, STA 2006 transmits CTS frame 2012 to AP 2002. CTS frame 2012 may also include a duration field (e.g., Duration/ID field) that indicates a NAV duration (not shown in FIG. 20). The NAV duration indicated in CTS frame 2012 may correspond to a remaining duration of NAV duration 2028 (e.g., NAV duration 2028, minus the duration of a SIFS between RTS frame 2010 and CTS frame 2012, minus the transmission duration of CTS frame 2012). On receiving CTS frame 2012 from STA 2006, AP 2002 initiates transmission of data frame 2014 to STA 2006. STA 2006 acknowledges reception of data frame 2014 by transmitting BA frame 2016 to AP 2002.

Subsequently, AP 2002 transmits MU-RTS (or MRTT) frame 2018 to allocate a duration 2034 of the TXOP to AP 2004. In an implementation, a transmitter address (TA) and a receiver address (RA) of MU-RTS (or MRTT) frame 2018 are set to AP 2002 and AP 2004, respectively. In an embodiment, MU-RTS (or MRTT) frame 2018 includes an allocation duration field indicating allocated duration 2034. In an implementation, MU-RTS (or MRTT) frame 2018 triggers transmission of CTS frame 2020 by AP 2004, e.g., a SIFS after reception of MU-RTS (or MRTT) frame 2018 by AP 2004. In an embodiment, MU-RTS (or MRTT) frame 2018 further includes an indication of a transmission, by AP 2002, of a frame within allocated duration 2034. In an implementation, the frame to be transmitted by AP 2002 within allocated duration 2034 may be CTS frame 2030, transmitted after (e.g., a SIFS after) MU-RTS frame 2018. The indication of the transmission of the frame by AP 2002 may thus indicate to AP 2004 that AP 2002 will transmit CTS frame 2030 at the same time that AP 2004 transmits CTS frame 2020. In an implementation, the indication may be provided in a common info field or in a user info field of MU-RTS (or MRTT) frame 2018. In an implementation, AP 2002 may choose to transmit CTS frame 2030 at the same time as CTS frame 2020 (rather than after CTS frame 2020 as in the procedure of FIG. 19) based on its knowledge that AP 2004 intends to use allocated duration 2034. That is, AP 2002 may have knowledge that AP 2004 intends to transmit CTS frame 2020, e.g., a SIFS after MU-RTS (or MRTT) frame 2018. In an implementation, a frame exchange between AP 2002 and AP 2004 (not shown in FIG. 20) may take place before AP 2002 transmits MU-RTS frame 2018. In an embodiment, the frame exchange may include a buffer status report poll (BSRP) frame from AP 2002 to AP 2004 and a buffer status report (BSR) frame from AP 2004 to AP 2002. In another embodiment, the frame exchange may include an initial control frame (ICF) from AP 2002 to AP 2004 and an initial control response frame from AP 2004 to AP 2002. In an embodiment, the frame exchange may be performed in addition or as an alternative to the exchange of RTS frame 2010 and CTS frame 2012. In an embodiment, the ICF may be a control frame transmitted by an AP (e.g., AP 2002) at the beginning of a TXOP of the AP to announce its intention to share a portion of the TXOP. Based on the frame exchange, AP 2002 may determine whether AP 2004 intends to use allocated duration 2034. As such, AP 2002 may choose to use the procedure described in FIG. 20, instead of the procedure described in FIG. 19. In an embodiment, AP 2002 transmits CTS frame 2030 based on receiving the BSR frame from AP 2004.

In another embodiment, instead of transmitting CTS frame 2030 at the same time as CTS frame 2020, AP 2002 may transmit MU-RTS (or MRTT) frame 2018 including a duration field (e.g., Duration/ID field) that indicates a NAV duration (not shown in FIG. 20). The NAV duration indicated in MU-RTS (or MRTT) frame 2018 may correspond to a duration overlapping allocated duration 2034 (e.g., allocated duration 2034, minus the transmission duration of MU-RTS (or MRTT) frame 2018). In an implementation, AP 2002 may choose to set the NAV duration to overlap allocated duration 2034 based on its knowledge that AP 2004 intends to use allocated duration 2034. For example, AP 2002 may have knowledge that AP 2004 intends to transmit CTS frame 2020, e.g., a SIFS after MU-RTS (or MRTT) frame 2018. In an implementation, a frame exchange between AP 2002 and AP 2004 (not shown in FIG. 20) may take place before AP 2002 transmits MU-RTS frame 2018. The frame exchange may include a buffer status report poll (BSRP) frame from AP 2002 to AP 2004 and a buffer status report (BSR) frame from AP 2004 to AP 2002. Alternatively, the frame exchange may include an initial control frame (ICF) from AP 2002 to AP 2004 and an initial control response frame from AP 2004 to AP 2002. Based on the frame exchange, AP 2002 may determine whether AP 2004 intends to use allocated duration 2034.

On receiving MU-RTS (or MRTT) frame 2018 from AP 2002, AP 2004 may be configured to transmit CTS frame 2020. In an embodiment, MU-RTS (or MRTT) frame 2018 triggers or solicits CTS frame 2020 from AP 2004. In an implementation, CTS frame 2020 may include a duration field that indicates a NAV duration (not shown in FIG. 20). The NAV duration indicated in CTS frame 2020 may overlap with allocated duration 2034. In an implementation, the NAV duration indicated in CTS frame 2020 corresponds to a remaining duration of allocated duration 2034 after CTS frame 2020. In an implementation, a receiver address (RA) of CTS frame 2020 is set to AP 2004.

On receiving CTS frame 2020 from AP 2004, STA 2008 may set an intra-BSS NAV based on the NAV duration indicated in CTS frame 2020. In an example, STA 2008 may set the intra-BSS NAV based on CTS frame 2020 having an RA value that is equal to the BSSID of the BSS or the BSSID of any BSS with which the STA 2008 is associated (e.g. AP 2004). With its intra-BSS NAV set to a non-zero value, STA 2008 may not transmit on the shared channel unless triggered by AP 2004. Other STAs not belonging to the BSS of AP 2004 (e.g., STA 2006) may set their basic NAVs based on the NAV duration indicated in CTS frame 2020. As such, CTS frame 2020 may provide an incremental TXOP protection that extends the initial TXOP protection provided by RTS frame 2010.

In an embodiment, as described above, AP 2002 may be configured to transmit CTS frame 2030 at the same time as CTS frame 2020 (e.g., a SIFS after transmission of MU-RTS frame 2018). In an implementation, to avoid interference with CTS frame 2020, CTS frame 2030 may be identical to CTS frame 2020. In an embodiment, CTS frame 2030 comprises a duration field indicating a duration that overlaps with allocated duration 2034. In an implementation, the duration corresponds to allocated duration 2034. In an implementation, the duration may be a NAV duration corresponding to the remaining duration of allocated duration 2034. In another implementation, the duration may be a NAV duration that AP 2002 and AP 2004 agreed to during the frame exchange between AP 2002 and AP 2004 (not shown in FIG. 20) that may take place before AP 2002 transmits MU-RTS frame 2018.

In an implementation, CTS frame 2030 may comprise an address of AP 2004 and/or a basic service set identifier (BSSID) of a BSS of AP 2004. In an implementation, the address of AP 2004 may be provided in a receiver address (RA) or a transmitter address (TA) of CTS frame 2030. In an implementation, the BSSID of the BSS of AP 2004 may be provided in a BSSID field of CTS frame 2030. Accordingly, a STA receiving a PPDU carrying CTS frame 2030 may classify the received PPDU as originating from the BSS of AP 2004. In particular, in example 2000, STA 2032, associated with AP 2002, may set its basic NAV, instead of its intra-BSS NAV, for the remaining of allocated duration 2034 based on CTS frame 2030. As such, although STA 2032 may be outside the communication range of AP 2004 and STA 2008, STA 2032 may not access the shared channel during allocated duration 2034 and may not interfere with the communication between AP 2004 and STA 2008.

Subsequently, AP 2004 may use allocated duration 2034 to transmit downlink data and/or receive uplink data to/from one or more associated STAs. For instance, in example 2000, AP 2004 uses allocated duration 2034 to send trigger frame 2022 to STA 2008. As NAV duration 2028 does not extend beyond trigger frame 2022, STA 2008 may have a basic NAV equal to zero when it receives trigger frame 2022. As such, STA 2008 may be able to respond to trigger frame 2022 by transmitting a TB PPDU 2024 to AP 2004. AP 2004 may acknowledge TB PPDU 2024 by transmitting a BA frame 2026 to STA 2008.

At the end of allocated duration 2034, or earlier in case AP 2004 returns the TXOP to AP 2002 before the end of allocated duration 204, AP 2002 may regain control of the TXOP without being impeded by STA 2032 which remains silent during allocated duration 2034. For example, as shown in FIG. 20, AP 2002 may regain control of the TXOP by transmitting a data frame 2036 to STA 2006.

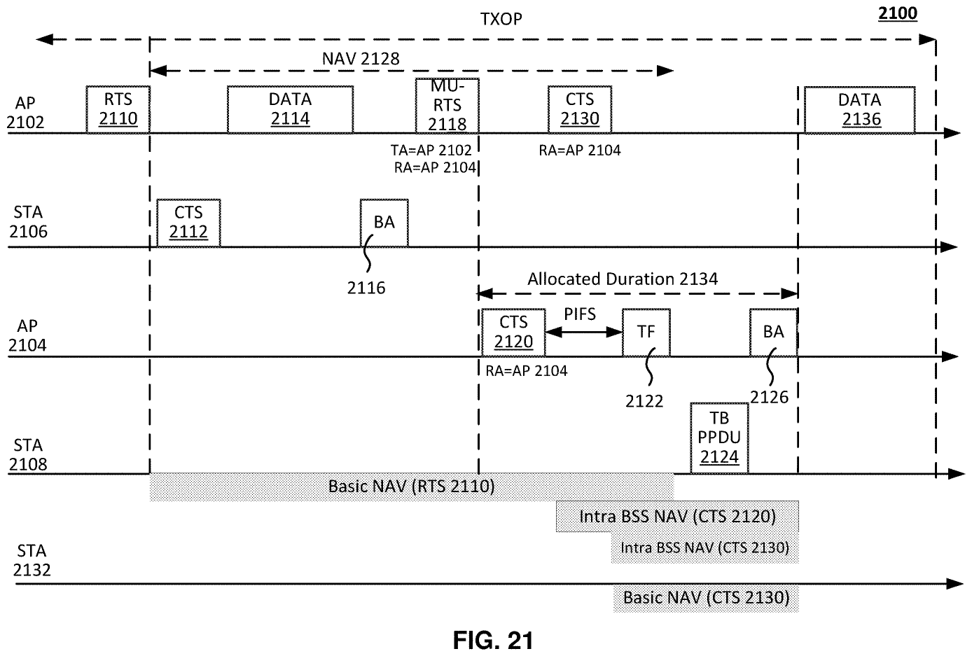

FIG. 21 illustrates an example 2100 of another CTDMA procedure according to an embodiment. As shown in FIG. 21, example 2100 includes an AP 2102, an AP 2104, a STA 2106, a STA 2108, and a STA 2132. APs 2102 and 2104 may form a coordinated AP set or may form part of a multi-AP group. AP 2102 may be the master or sharing AP and AP 2104 may be the slave or shared AP. STAs 2106 and 2132 may be associated with AP 2102 and STA 2108 may be associated with AP 2104.

As shown in FIG. 21, example 2100 may begin with AP 2102 gaining access to the shared channel and transmitting an RTS frame 2110 to STA 2106. RTS frame 2110 may be similar to RTS frame 1510 described above. However, unlike RTS frame 1510, in which the duration field (e.g., Duration/ID field) is set to the duration of the TXOP, in RTS frame 2110, the duration field is set to a NAV duration 2128 that is only a portion of the duration of the TXOP. For example, AP 2102 may select NAV duration 2128 to correspond to an estimated time required for the transmission of one or more frames after RTS frame 2110. For instance, in example 2100, knowing an amount of buffered downlink traffic to STA 2106 and wishing to share a portion of the remainder of the TXOP with AP 2104, AP 2102 sets NAV duration 2128 to correspond to the estimated time required for the transmission of a CTS frame 2112 by STA 2106 to AP 2102, a data frame 2114 by AP 2102 to STA 2106, and a BA frame 2116 by STA 2106 to AP 2102, followed by an MU-RTS (or an MRTT) frame 2118 by AP 2102 to AP 2104, a CTS frame 2120 by AP 2104 to AP 2102, a CTS frame 2130 by AP 2102 to AP 2104, and a trigger frame 2122 by AP 2104 to STA 2108. The estimated time may include any interframe space between successive frames. In other embodiments, however, AP 2102 may set NAV duration 2128 to be longer or shorter than in example 2100.

On receiving RTS frame 2110, STA 2108 sets its basic NAV according to NAV duration 2128. STA 2108 may refrain from transmitting on the shared channel as long as its basic NAV is non-zero, e.g., until the end of NAV duration 2128.

On receiving RTS frame 2110 from AP 2102, STA 2106 transmits CTS frame 2112 to AP 2102. CTS frame 2112 may also include a duration field (e.g., Duration/ID field) that indicates a NAV duration (not shown in FIG. 21). The NAV duration indicated in CTS frame 2112 may correspond to a remaining duration of NAV duration 2128 (e.g., NAV duration 2128, minus the duration of a SIFS between RTS frame 2110 and CTS frame 2112, minus the transmission duration of CTS frame 2112). On receiving CTS frame 2112 from STA 2106, AP 2102 initiates transmission of data frame 2114 to STA 2106. STA 2106 acknowledges reception of data frame 2114 by transmitting BA frame 2116 to AP 2102. In an embodiment, RTS frame 2110 and CTS frame 2112 may be replaced by an initial control frame (ICF) and an initial control response (ICR) frame respectively. In an embodiment, the ICF may be a control frame transmitted by an AP (e.g. AP 2102) at the beginning of a TXOP of the AP to announce its intention to share a portion of the TXOP.

Subsequently, AP 2102 transmits MU-RTS (or MRTT) frame 2118 to allocate a duration 2134 of the TXOP to AP 2104. In an implementation, a transmitter address (TA) and a receiver address (RA) of MU-RTS (or MRTT) frame 2118 are set to AP 2102 and AP 2104, respectively. In an embodiment, MU-RTS (or MRTT) frame 2118 includes an allocation duration field indicating allocated duration 2134. In an implementation, MU-RTS (or MRTT) frame 2118 triggers transmission of CTS frame 2120 by AP 2104, e.g., a SIFS after reception of MU-RTS (or MRTT) frame 2118 by AP 2104. In an embodiment, rather than MU-RTS (or MRTT) frame 2118 including an indication of a transmission, by AP 2102, of a frame within allocated duration 2134 (as in example 1900 for example), MU-RTS (or MRTT) frame 2118 may configure or include an indication for AP 2104 to wait at least a pre-determined duration, after transmitting CTS frame 2120, before initiating a further transmission over the shared channel. In an implementation, the pre-determined duration may be equal to the duration of a point coordination function (PCF) interframe space (PIFS). In an implementation, the indication may be provided in a common info field or in a user info field of MU-RTS (or MRTT) frame 2118.

On receiving MU-RTS (or MRTT) frame 2118 from AP 2102, AP 2104 may be configured to transmit CTS frame 2120. In an embodiment, MU-RTS (or MRTT) frame 2118 triggers or solicits CTS frame 2120 from AP 2104. In an implementation, CTS frame 2120 may include a duration field that indicates a NAV duration (not shown in FIG. 21). The NAV duration indicated in CTS frame 2120 may overlap with allocated duration 2134. In an implementation, the NAV duration indicated in CTS frame 2120 corresponds to a remaining duration of allocated duration 2134 after CTS frame 2120. In an implementation, a receiver address (RA) of CTS frame 2120 is set to AP 2104.

On receiving CTS frame 2120 from AP 2104, STA 2108 may set an intra-BSS NAV based on the NAV duration indicated in CTS frame 2120. In an example, STA 2108 may set the intra-BSS NAV based on CTS frame 2120 having an RA value that is equal to the BSSID of the BSS or the BSSID of any BSS with which the STA 2108 is associated (e.g. AP 2104). With its intra-BSS NAV set to a non-zero value, STA 2108 may not transmit on the shared channel unless triggered by AP 2104. Other STAs not belonging to the BSS of AP 2104 (e.g., STA 2106) may set their basic NAVs based on the NAV duration indicated in CTS frame 2120. As such, CTS frame 2120 may provide an incremental TXOP protection that extends the initial TXOP protection provided by RTS frame 2110.

In an embodiment, AP 2102 may be configured not to set its basic NAV based on CTS frame 2120. Further, AP 2102 may be configured to transmit CTS frame 2130 in response to CTS frame 2120. In an implementation, AP 2102 may be configured to transmit CTS frame 2130 no later than the pre-determined duration (e.g., PIFS) indicated in MU-RTS (or MRTT) frame 2118, from receiving CTS frame 2120. As MU-RTS (or MRTT) frame 2118 configures AP 2104 to wait for at least the pre-determined duration after transmitting CTS frame 2120 before initiating a further transmission on the shared channel, AP 2102 is guaranteed access to the shared channel to transmit CTS frame 2130. In an embodiment, CTS frame 2130 comprises a duration field indicating a duration that overlaps with allocated duration 2134. In an implementation, the duration corresponds to allocated duration 2134. In an implementation, the duration may be a NAV duration corresponding to the remaining duration of allocated duration 2134. In an implementation, the duration may be a NAV duration corresponding to the NAV duration indicated in CTS frame 2120 by AP 2104.

In an implementation, CTS frame 2130 may comprise an address of AP 2104 and/or a basic service set identifier (BSSID) of a BSS of AP 2104. In an implementation, the address of AP 2104 may be provided in a receiver address (RA) or a transmitter address (TA) of CTS frame 2130. In an implementation, the BSSID of the BSS of AP 2104 may be provided in a BSSID field of CTS frame 2130. Accordingly, a STA receiving a PPDU carrying CTS frame 2130 may classify the received PPDU as originating from the BSS of AP 2104. In particular, in example 2100, STA 2108 may only update its intra-BSS NAV based on CTS frame 2130 and may not set its basic NAV. In contrast, STA 2132, associated with AP 2102, may set its basic NAV, instead of its intra-BSS NAV, for the remaining of allocated duration 2134 based on CTS frame 2130. As such, although STA 2132 may be outside the communication range of AP 2104 and STA 2108, STA 2132 may not access the shared channel during allocated duration 2134 and may not interfere with the communication between AP 2104 and STA 2108.

Subsequently, AP 2104 may use allocated duration 2134 to transmit downlink data and/or receive uplink data to/from one or more associated STAs. For instance, in example 2100, AP 2104 uses allocated duration 2134 to send trigger frame 2122 to STA 2108. AP 2104 may transmit trigger frame 2122 a SIFS after CTS frame 2130. As NAV duration 2128 does not extend beyond trigger frame 2122, STA 2108 may have a basic NAV equal to zero when it receives trigger frame 2122. As such, STA 2108 may be able to respond to trigger frame 2122 by transmitting a TB PPDU 2124 to AP 2104. AP 2104 may acknowledge TB PPDU 2124 by transmitting a BA frame 2126 to STA 2108.

At the end of allocated duration 2134, or earlier in case AP 2104 returns the TXOP to AP 2102 before the end of allocated duration 214, AP 2102 may regain control of the TXOP without being impeded by STA 2132 which remains silent during allocated duration 2134. For example, as shown in FIG. 21, AP 2102 may regain control of the TXOP by transmitting a data frame 2136 to STA 2106.

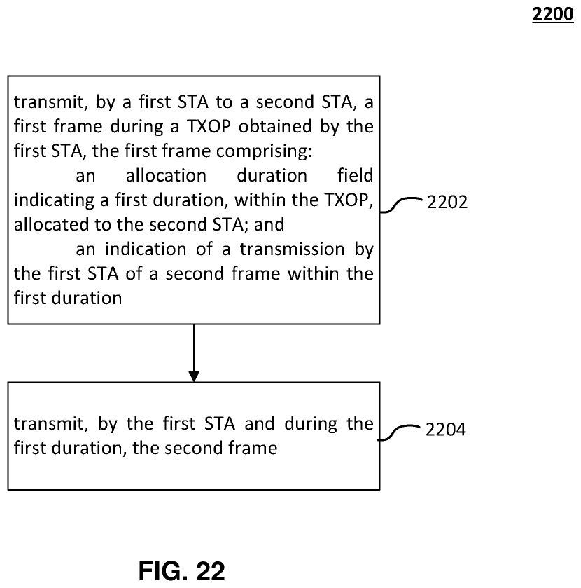

FIG. 22 illustrates an example process 2200 according to an embodiment. Example process 2200 may be performed by a first STA. The first STA may be an AP, such as AP 1902 or 2002, for example. The first STA may be a member of a coordinated AP set or a multi-AP group comprising a second STA. The second STA may be an AP, such as AP 1904 or 2004. The first STA may be master AP or a sharing AP and the second STA may be slave AP or a shared AP. As shown in FIG. 22, process 2200 may include steps 2202 and 2204.

Step 2202 includes transmitting, by the first STA to the second STA, a first frame during a TXOP obtained by the first STA. The first frame may comprise an allocation duration field indicating a first duration, within the TXOP, allocated to the second STA. The first frame may further comprise an indication of a transmission by the first STA of a second frame within the first duration. In an implementation, the first frame comprises an MU-RTS or an MRTT frame. In an implementation, where the first frame is an MRTT frame, the indication may be provided in a common info field or in a user info field of the MRTT frame.

Step 2204 includes transmitting, by the first STA and during the first duration, the second frame. In an implementation, the second frame comprises a CTS frame.

In an embodiment, process 2200 further comprises receiving, by the first STA from the second STA and during the first duration, a third frame comprising a duration field indicating a second duration overlapping the first duration. In an embodiment, the third frame comprises a CTS frame.

In an embodiment, the first frame solicits the third frame from the second STA. In an embodiment, transmitting the second frame in step 2204 comprises transmitting the second frame in response to the third frame. In an embodiment, transmitting the second frame in step 2204 comprises transmitting the second frame a SIFS after receiving the third frame.

In an embodiment, process 2200 further comprises receiving, by the first STA, a fourth frame after transmitting the second frame. In an embodiment, the fourth frame comprises a trigger frame triggering a transmission from a third STA. The fourth frame may be transmitted by the second STA to trigger a transmission from the third STA to the second STA.

In another embodiment, transmitting the second frame in step 2204 comprises transmitting the second frame a SIFS after transmitting the first frame. In another embodiment, transmitting the second frame in step 2204 further comprises transmitting the second frame based on receiving a fifth frame from the second STA. In an implementation, the fifth frame comprises a BSR frame. The BSR frame comprises a BSR of the second STA. In an embodiment, process 2200 may further comprise transmitting, by the first STA to the second STA, a sixth frame and receiving the fifth frame in response to the sixth frame. In an implementation, the sixth frame comprises a BSRP frame.

In an embodiment, the second frame comprises a second duration field indicating a third duration overlapping the first duration. In an embodiment, the second duration field indicates the first duration.

In an embodiment, the second frame comprises an address of the second STA or a BSSID of a BSS of the second STA. In an implementation, the second frame comprises an RA field, a TA field, or a BSSID field. In an implementation, the RA, TA, or the BSSID field comprises the address of the second STA or the BSSID of the BSS of the second STA.

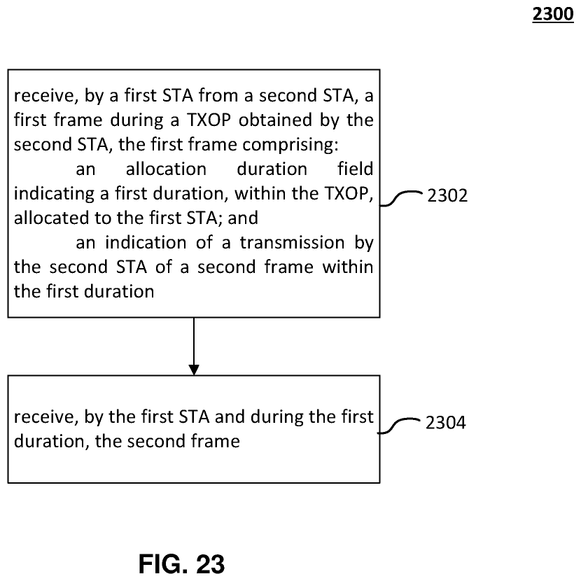

FIG. 23 illustrates another example process 2300 according to an embodiment. Example process 2300 may be performed by a first STA. The first STA may be an AP, such as AP 1904 or 2004, for example. The first STA may be a member of a coordinated AP set or a multi-AP group comprising a second STA. The second STA may be an AP, such as AP 1902 or 2002. The first STA may be slave AP or a shared AP and the second STA may be master AP or a sharing AP. As shown in FIG. 23, process 2300 may include steps 2302 and 2304.

Step 2302 includes receiving, by the first STA from the second STA, a first frame during a TXOP obtained by the second STA. The first frame may comprise an allocation duration field indicating a first duration, within the TXOP, allocated to the first STA. The first frame may further comprise an indication of a transmission by the second STA of a second frame within the first duration. In an implementation, the first frame comprises an MU-RTS or an MRTT frame. In an implementation, where the first frame is an MRTT frame, the indication may be provided in a common info field or in a user info field of the MRTT frame.

Step 2304 includes receiving, by the first STA and during the first duration, the second frame. In an implementation, the second frame comprises a CTS frame.

In an embodiment, process 2300 further comprises transmitting, by the first STA to the second STA and during the first duration, a third frame comprising a duration field indicating a second duration overlapping the first duration. In an embodiment, the third frame comprises a CTS frame.

In an embodiment, the first frame solicits the third frame from the first STA. In an embodiment, receiving the second frame in step 2304 comprises receiving the second frame in response to the third frame. In an embodiment, receiving the second frame in step 2304 comprises receiving the second frame a SIFS after transmitting the third frame.

In an embodiment, process 2300 further comprises transmitting, by the first STA, a fourth frame after receiving the second frame. In an embodiment, the fourth frame comprises a trigger frame triggering a transmission from a third STA. The fourth frame may be transmitted by the first STA to trigger a transmission from the third STA to the first STA.

In another embodiment, receiving the second frame in step 2304 comprises receiving the second frame a SIFS after receiving the first frame. In another embodiment, receiving the second frame in step 2304 further comprises receiving the second frame based on transmitting a fifth frame to the second STA. In an implementation, the fifth frame comprises a BSR frame. The BSR frame comprises a BSR of the first STA. In an embodiment, process 2300 may further comprise receiving, by the first STA from the second STA, a sixth frame and transmitting the fifth frame in response to the sixth frame. In an implementation, the sixth frame comprises a BSRP frame.

In an embodiment, the second frame comprises a second duration field indicating a third duration overlapping the first duration. In an embodiment, the second duration field indicates the first duration.

In an embodiment, the second frame comprises an address of the first STA or a BSSID of a BSS of the first STA. In an implementation, the second frame comprises an RA field, a TA field, or a BSSID field. In an implementation, the RA, TA, or the BSSID field comprises the address of the first STA or the BSSID of the BSS of the first STA.

In another example process according to embodiments, a first STA transmits to a second STA a first frame during a TXOP obtained by the first STA. The first STA may be a master AP or a sharing AP. The second STA may be a slave AP or a shared AP. The first and second STA may be members of a coordinated AP set or a multi-AP group. The first frame may comprise an allocation duration field indicating a first duration, within the TXOP, allocated to the second STA. Additionally the first frame may comprise an indication of a TXOP sharing mode for the second STA. After transmitting the first frame to the second STA, the first AP receives from the second STA a second frame a SIFS after the first frame and a third frame at least a pre-determined duration after the second frame. The pre-determined duration may be equal to a PIFS. The second frame and/or the second frame may be received in response to the first frame.

1. A first access point (AP) comprising:
one or more processors; and
memory storing instructions that, when executed by the one or more processors, cause the first AP to:
transmit, to a second AP, a coordinated time division multiple access (Co-TDMA) initial control frame (ICF) soliciting a response from the second AP indicating whether the second AP intends to receive a time allocation from the first AP within a transmission opportunity (TXOP) obtained by the first AP, wherein the Co-TDMA ICF comprises:
a first field indicating an identifier of the second AP, assigned by the first AP during an MAPC agreement negotiation between the first AP and the second AP; and
a second field indicating a duration based on time required, by the second AP, to transmit the response;
receive, from the second AP during the duration indicated by the second field of the Co-TDMA ICF, and based on the first field of the Co-TDMA ICF indicating the identifier of the second AP, a Co-TDMA ICR comprising a third field set to a first value indicating whether the second AP requests the time allocation from the first AP within the TXOP.

2. The first AP of claim 1, wherein the Co-TDMA ICF further comprises a fourth field indicating a maximum duration of the TXOP that the first AP is able to allocate to the second AP.

3. The first AP of claim 2, wherein the first value is based on the maximum duration indicated by the fourth field of the Co-TDMA ICF.

4. The first AP of claim 1, wherein the first AP is a Co-TDMA coordinating AP and the second AP is a Co-TDMA coordinated AP.

5. The first AP of claim 1, wherein the first AP and the second AP are members of a multi-AP group.

6. The first AP of claim 1, wherein the Co-TDMA ICF comprises a user info field, and wherein the user info field comprises the first field.

7. The first AP of claim 1, wherein the Co-TDMA ICR is received a short interframe space (SIFS) duration after the Co-TDMA ICF is transmitted.

8. The first AP of claim 1, wherein the Co-TDMA ICF comprises a buffer status report poll (BSRP) trigger frame.

9. A first access point (AP) comprising:
one or more processors; and
memory storing instructions that, when executed by the one or more processors, cause the first AP to:
receive, from a second AP, a coordinated time division multiple access (Co-TDMA) initial control frame (ICF) soliciting a response from the first AP indicating whether the first AP intends to receive a time allocation from the second AP within a transmission opportunity (TXOP) obtained by the second AP, wherein the Co-TDMA ICF comprises:
a first field indicating an identifier of the first AP, assigned by the second AP during an MAPC agreement negotiation between the second AP and the first AP; and
a second field indicating a duration based on time required, by the first AP, to transmit the response;
transmit, to the second AP during the duration indicated by the second field of the Co-TDMA ICF, and based on the first field of the Co-TDMA ICF indicating the identifier of the first AP, a Co-TDMA ICR comprising a third field set to a first value indicating whether the first AP requests the time allocation from the second AP within the TXOP.

10. The first AP of claim 9, wherein the Co-TDMA ICF further comprises a fourth field indicating a maximum duration of the TXOP that the second AP is able to allocate to the first AP.

11. The first AP of claim 10, wherein the first value is based on the maximum duration indicated by the fourth field of the Co-TDMA ICF.

12. The first AP of claim 9, wherein the first AP is a Co-TDMA coordinated AP and the second AP is a Co-TDMA coordinating AP.

13. The first AP of claim 9, wherein the first AP and the second AP are members of a multi-AP group.

14. The first AP of claim 9, wherein the Co-TDMA ICF comprises a user info field, and wherein the user info field comprises the first field.

15. The first AP of claim 9, wherein the Co-TDMA ICR is transmitted a short interframe space (SIFS) duration after the Co-TDMA ICF is received.

16. The first AP of claim 9, wherein the Co-TDMA ICF comprises a buffer status report poll (BSRP) trigger frame.

17. A non-transitory computer-readable medium storing instructions that, when executed by one or more processors of a first access point (AP), cause the first AP to:
transmit, to a second AP, a coordinated time division multiple access (Co-TDMA) initial control frame (ICF) soliciting a response from the second AP indicating whether the second AP intends to receive a time allocation from the first AP within a transmission opportunity (TXOP) obtained by the first AP, wherein the Co-TDMA ICF comprises:
a first field indicating an identifier of the second AP, assigned by the first AP during an MAPC agreement negotiation between the first AP and the second AP; and
a second field indicating a duration based on time required, by the second AP, to transmit the response;
receive, from the second AP during the duration indicated by the second field of the Co-TDMA ICF, and based on the first field of the Co-TDMA ICF indicating the identifier of the second AP, a Co-TDMA ICR comprising a third field set to a first value indicating whether the second AP requests the time allocation from the first AP within the TXOP.

18. The non-transitory computer-readable medium of claim 17, wherein the Co-TDMA ICF further comprises a fourth field indicating a maximum duration of the TXOP that the first AP is able to allocate to the second AP.

19. The non-transitory computer-readable medium of claim 18, wherein the first value is based on the maximum duration indicated by the fourth field of the Co-TDMA ICF.

20. The non-transitory computer-readable medium of claim 17, wherein the first AP is a Co-TDMA coordinating AP and the second AP is a Co-TDMA coordinated AP.
